(19) United States
(12) Patent Application Publication
(10) Pub. No.: US 2024/0150912 A1
(43) Pub. Date: May 9, 2024

(54) PHOTOELECTRODE AND METHOD OF PREPARATION THEREOF

(71) Applicant: KING FAHD UNIVERSITY OF PETROLEUM AND MINERALS, Dhahran (SA)

(72) Inventors: Abdul Zeeshan KHAN, Dhahran (SA); Tarek Abdelsamad Abdelrahman KANDIEL, Dhahran (SA); Safwat Sayed Abdel-Azeim ABDELLATIF, Dhahran (SA); Tahir Naveed JAHANGIR, Dhahran (SA); Khalid Rashid ALHOOSHANI, Dhahran (SA)

(73) Assignee: KING FAHD UNIVERSITY OF PETROLEUM AND MINERALS, Dhahran (SA)

(21) Appl. No.: 17/980,160

(22) Filed: Nov. 3, 2022

(51) Int. Cl. C25B 11/053; C03C 17/42; C25B 1/04; C25B 1/55; C25B 9/50; C25B 11/067; C25B 11/095

(52) U.S. Cl. CPC C25B 11/053; C03C 17/42; C25B 1/04; C25B 1/55; C25B 9/50; C25B 11/067; C25B 11/095; C03C 2218/111; C03C 2218/32

(57) ABSTRACT

A photoelectrode is provided. The photoelectrode includes a transparent substrate. The photoelectrode further includes a layer of crystalline hematite nanoparticles at least partially covering a surface of the transparent substrate. The photoelectrode further includes a phosphate ions (Pi) interfacial layer coated on a surface of the layer of crystalline hematite nanoparticles. The photoelectrode further includes a plurality of CoFe-Prussian blue analogues (CoFe-PBA) particles uniformly disposed on a surface of the phosphate (Pi) interfacial layer. Methods of making the photoelectrode and photoelectrochemical (PEC) water splitting are also provided.

### STATEMENT OF ACKNOWLEDGEMENT

This research was supported by the Deanship of Scientific Research (DSR) at King Fahd University of Petroleum and Minerals under the project number SR 201010. S. A.

### STATEMENT REGARDING PRIOR DISCLOSURE BY THE INVENTORS

Aspects of this technology are described in an article “Phosphate ions interfacial drift layer to improve the performance of CoFe-Prussian blue hematite photoanode toward water splitting” published in Applied Catalysis B: Environmental, 2022, Volume 304, May 2022, 121014, which is incorporated herein by reference in its entirety.

### BACKGROUND

### Technical Field

The present disclosure is directed to a photoelectrode, and a method of making the photoelectrode.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Photoelectrochemical (PEC) cells are among the best promising approaches to mimic the natural photosynthesis process in harvesting and storing solar energy as chemical fuels [M. G. Walter, E. L. Warren, J. R. McKone, S. W. Boettcher, Q. Mi, E. A. Santori, N. S. Lewis, Solar Water Splitting Cells, Chem. Rev. 110 (2010) 6446-6473]. Consequently, PEC water splitting has attracted more consideration as a potential technology for storing solar energy as H2 chemical fuel with zero carbon dioxide emission. However, the high rate of charge carrier recombination and slow kinetics of water oxidation at most photoelectrode surfaces limit the overall PEC water splitting efficiency [H.-M. Li, Z.-Y. Wang, H.-J. Jing, S.-S. Yi, S.-X. Zhang, X.-Z. Yue, Z.-T. Zhang, H.-X. Lu, D.-L. Chen, Synergetic integration of passivation layer and oxygen vacancy on hematite nanoarrays for boosted photoelectrochemical water oxidation, Appl. Catal. B Environ. 284 (2021) 119760]. Water oxidation involves multi-hole transfer processes and thus long-life holes are required to produce molecular oxygen [F. Le Formal, E. Pastor, S. D. Tilley, C. A. Mesa, S. R. Pendlebury, M. Grätzel, J. R. Durrant, Rate Law Analysis of Water Oxidation on a Hematite Surface, J. Am. Chem. Soc. 137 (2015) 6629-6637].

Besides the need to accelerate the kinetics of water oxidation, the ideal photoanode should be low cost, have high stability, exhibit suitable band structure, and possess excellent light-harvesting properties. Despite substantial improvements in the field of PEC water splitting, photoanodes that satisfy all of these criteria have not been discovered yet. Thus, improvement of conventional photoelectrodes is required to minimize the charge carrier recombination, improve the charge transfer efficiency, and catalyze the water oxidation process. The most appropriate n-type semiconductor materials, which are commonly employed as photoanodes in PEC cells, are metal oxides such as TiO₂ [C. Das, P. Roy, M. Yang, H. Jha, P. Schmuki, Nb doped TiO₂ nanotubes for enhanced photoelectrochemical water-splitting, Nanoscale. 3 (2011) 3094], α-Fe₂O₃ [A. Y. Ahmed, M. G. Ahmed, T. A. Kandiel, Hematite photoanodes with size-controlled nanoparticles for enhanced photoelectrochemical water oxidation, Appl. Catal. B Environ. 236 (2018) 117-124], WO₃ [D.-D. Qin, C.-L. Tao, S. A. Friesen, T.-H. Wang, O. K. Varghese, N.-Z. Bao, Z.-Y. Yang, T. E. Mallouk, C. A. Grimes, Dense layers of vertically oriented WO 3 crystals as anodes for photoelectrochemical water oxidation, Chem. Commun. 48 (2012) 729-731], and BiVO₄ [J. H. Kim, J. S. Lee, Elaborately Modified BiVO₄ Photoanodes for Solar Water Splitting, Adv. Mater. 31 (2019) 1806938] due to their high chemical stability.

In contrast, α-Fe₂O₃ (hematite) is considered to be very appealing due to many distinct merits such as its environmentally benign nature, stability in the water at a wide range of pH (4-14), abundantly available in earth's crust (6.3 wt. %), and corresponding valence band potential perfectly matches the thermodynamic requirements for water oxidation [C. Li, Z. Luo, T. Wang, J. Gong, Surface, Bulk, and Interface: Rational Design of Hematite Architecture toward Efficient Photo-Electrochemical Water Splitting, Adv. Mater. 30 (2018) 1707502].

Moreover, hematite exhibits a bandgap of 1.9-2.2 electron volts (eV), and thus absorbs about 40% of the solar spectrum and theoretically can generate 12.6 milliampere per square centimeter (mA/cm²) under standard test conditions (STC, 1.0 sun, and AM 1.5 G) [C. Li, Z. Luo, T. Wang, J. Gong, Surface, Bulk, and Interface: Rational Design of Hematite Architecture toward Efficient Photo-Electrochemical Water Splitting, Adv. Mater. 30 (2018) 1707502; K. Sivula, F. Le Formal, M. Grätzel, F. Le Formal, M. Grätzel, Solar Water Splitting: Progress Using Hematite (α-Fe2O3) Photoelectrodes, ChemSusChem. 4 (2011) 432-449].

Nevertheless, the PEC activity of hematite is still limited by the rapid charge carrier recombination in the bulk, short diffusion length of photogenerated holes (i.e. 2-4 nanometers (nm)), and high rate of surface recombination [H.-J. Ahn, M.-J. Kwak, J.-S. Lee, K.-Y. Yoon, J.-H. Jang, Nanoporous hematite structures to overcome short diffusion lengths in water splitting, J. Mater. Chem. A. 2 (2014) 19999-20003; M. Barroso, S. R. Pendlebury, A. J. Cowan, J. R. Durrant, Charge carrier trapping, recombination and transfer in hematite (α-Fe₂O₃) water splitting photoanodes, Chem. Sci. 4 (2013) 2724]. In particular, the fast surface recombination limits the accessibility of holes at the surface and thus suppresses the rate of water oxidation.

To overcome such limitations, various methodologies (such as heterojunction fabrication, elemental doping, morphology engineering, and loading with water oxidation catalyst (WOC)) have been investigated to promote the PEC water oxidation process. For instance, doping with non-metal and metal dopants like P [Y. Zhang, S. Jiang, W. Song, P. Zhou, H. Ji, W. Ma, W. Hao, C. Chen, J. Zhao, Nonmetal P-doped hematite photoanode with enhanced electron mobility and high water oxidation activity, Energy Environ. Sci. 8 (2015) 1231-1236], Ti 4+[D. Cao, W. Luo, J. Feng, X. Zhao, Z. Li, Z. Zou, Cathodic shift of onset potential for water oxidation on a Ti 4+ doped Fe 2 O 3 photoanode by suppressing the back reaction, Energy Environ. Sci. 7 (2014) 752-759], Sn⁴⁺ [M. Li, Y. Yang, Y. Ling, W. Qiu, F. Wang, T. Liu, Y. Song, X. Liu, P. Fang, Y. Tong, Y. Li, Morphology and Doping Engineering of Sn-Doped Hematite Nanowire Photoanodes, Nano Lett. 17 (2017) 2490-2495], Zr⁴⁺ [S. Shen, P. Guo, D. A. Wheeler, J. Jiang, S. A. Lindley, C. X. Kronawitter, J. Z. Zhang, L. Guo, S. S. Mao, Physical and photoelectrochemical properties of Zr-doped hematite nanorod arrays, Nanoscale. 5 (2013) 9867], among many others has been tested to enhance conductivity and extend hole diffusion length. Passivating surface states of bare hematite is also a potential approach for enhancing the density of photogenerated holes at the hematite surface and accelerating the water oxidation kinetics [S. D. Tilley, M. Cornuz, K. Sivula, M. Grätzel, Light-Induced Water Splitting with Hematite: Improved Nanostructure and Iridium Oxide Catalysis, Angew. Chemie Int. Ed. 49 (2010) 6405-6408].

For instance, passivating hematite surface with noble metal co-catalysts (e.g. IrO₂ and RuO₂ [P. Dias, L. Andrade, A. Mendes, Hematite-based photoelectrode for solar water splitting with very high photovoltage, Nano Energy. 38 (2017) 218-231; D. K. Zhong, M. Cornuz, K. Sivula, M. Grätzel, D. R. Gamelin, Photo-assisted electrodeposition of cobalt-phosphate (Co—Pi) catalyst on hematite photoanodes for solar water oxidation, Energy Environ. Sci. 4 (2011) 1759]) exhibited a positive impact on efficiency, but corresponding high price and paucity prohibit their use at a large scale.

Alternatively, transition metal-based materials such as Co—Pi [D. K. Zhong, M. Cornuz, K. Sivula, M. Grätzel, D. R. Gamelin, Photo-assisted electrodeposition of cobalt-phosphate (Co—Pi) catalyst on hematite photoanodes for solar water oxidation, Energy Environ. Sci. 4 (2011) 1759; D. K. Zhong, D. R. Gamelin, Photoelectrochemical Water Oxidation by Cobalt Catalyst (“Co-Pi”)/α-Fe₂O₃ Composite Photoanodes: Oxygen Evolution and Resolution of a Kinetic Bottleneck, J. Am. Chem. Soc. 132 (2010) 4202-4207], NiFe—layer double hydroxide (LDH) [Y. Bin Park, J. H. Kim, Y. J. Jang, J. H. Lee, M. H. Lee, B. J. Lee, D. H. Youn, J. S. Lee, Exfoliated NiFe Layered Double Hydroxide Cocatalyst for Enhanced Photoelectrochemical Water Oxidation with Hematite Photoanode, ChemCatChem. 11 (2019) 443-448], phosphate ions (Pi) [J. Y. Kim, J. W. Jang, D. H. Youn, G. Magesh, J. S. Lee, A stable and efficient hematite photoanode in a neutral electrolyte for solar water splitting: Towards stability engineering, Adv. Energy Mater. 4 (2014) 1-7.], and CoFe-Prussian Blue Analogue (CoFe-PBA) [P. Tang, L. Han, F. S. Hegner, P. Paciok, M. Biset-Peiro, H. Du, X. Wei, L. Jin, H. Xie, Q. Shi, T. Andreu, M. Lira-CantU, M. Heggen, R. E. Dunin-Borkowski, N. Lopez, J. R. Galan-Mascaros, J. R. Morante, J. Arbiol, Boosting Photoelectrochemical Water Oxidation of Hematite in Acidic Electrolytes by Surface State Modification, Adv. Energy Mater. 1901836 (2019) 1901836] were effectively utilized to decrease the surface charge recombination and hold the photogenerated holes at the surface for a time scale suitable for the water oxidation process.

The ideal passivating materials/catalysts for the surface modification of hematite should have a good ability to store the photogenerated holes, making them available for oxygen evolution reactions (OER) at an efficient charge transfer rate. Unfortunately, most of the passivation layers and OER catalysts cannot fulfill both criteria. Thus, rationally designed photoanodes should be modified with interfacial layer to attract and hold the photogenerated holes at the surface and with OER catalyst to accomplish the water oxidation process at an adequate rate. By this approach, the requirements of the water oxidation process can be satisfied. Kim et al. have reported enhanced PEC activity and stable water oxidation on hematite photoanode modified with phosphate ions (Pi) [J. Y. Kim, J. W. Jang, D. H. Youn, G. Magesh, J. S. Lee, A stable and efficient hematite photoanode in a neutral electrolyte for solar water splitting: Towards stability engineering, Adv. Energy Mater. 4 (2014) 1-7].

It was concluded that the phosphate ions anchored to the surface of hematite generate a negative electrostatic field, which stimulates the photogenerated holes separation and enhances their transfer to the surface of hematite. Moreover, Wang et al. have utilized various phosphate solutions (Na₃PO₄, Na₂HPO₄, NaH₂PO₄) to modify the hematite photoanodes and reached 0.02, 0.58, and 0.81 mA/cm² at 1.23 V_{RHE}, respectively [M. Wang, H. Wang, Q. Wu, C. Zhang, S. Xue, Morphology regulation and surface modification of hematite nanorods by aging in phosphate solutions for efficient PEC water splitting, Int. J. Hydrogen Energy. 41 (2016) 6211-6219].

Additionally, the CoFe-PBA was also found to be an effective, robust and inexpensive water oxidation electrocatalyst due to (i) active and stable in aqueous solutions with various pH values, from extremely acidic to extremely basic conditions; (ii) non-toxic; (iii) low overpotential for water oxidation; (iv) simple and easy to prepare [P. Tang, L. Han, F. S. Hegner, P. Paciok, M. Biset-Peiró, H. Du, X. Wei, L. Jin, H. Xie, Q. Shi, T. Andreu, M. Lira-Cantú, M. Heggen, R. E. Dunin-Borkowski, N. López, J. R. Galan-Mascaros, J. R. Morante, J. Arbiol, Boosting Photoelectrochemical Water Oxidation of Hematite in Acidic Electrolytes by Surface State Modification, Adv. Energy Mater. 1901836 (2019) 1901836; B. Moss, F. S. Hegner, S. Corby, S. Selim, L. Francàs, N. López, S. Giménez, J.-R. Galán-Mascarós, J. R. Durrant, Unraveling Charge Transfer in CoFe Prussian Blue Modified BiVO 4 Photoanodes, ACS Energy Lett. 4 (2019) 337-342; L. Han, P. Tang, Á. Reyes-Carmona, B. Rodriguez-Garcia, M. Torrens, J. R. Morante, J. Arbiol, J. R. Galan-Mascaros, Enhanced Activity, and Acid pH Stability of Prussian Blue-type Oxygen Evolution Electrocatalysts Processed by Chemical Etching, J. Am. Chem. Soc. 138 (2016) 16037-16045].

Hegner et al. have modified BiVO₄ with CoFe-PBA co-catalyst and obtained 0.92 mA/cm² at 1.23 V_{RHE} and they presented an extraordinary 50 hours stability [F. S. Hegner, I. Herraiz-Cardona, D. Cardenas-Morcoso, N. Lopez, J. R. Galán-Mascarós, S. Gimenez, Cobalt Hexacyanoferrate on BiVO₄ Photoanodes for Robust Water Splitting, ACS Appl. Mater. Interfaces. 9 (2017) 37671-37681]. The decoration of hematite with CoFe-PBA was also investigated by the same group and they reached only 0.2 mA/cm² at 1.23 V_{RHE}, because the Co ta g states of CoFe-PBA, which is responsible for water oxidation, is located slightly lower than the valence band (VB) edge of hematite photoanode [F. S. Hegner, D. Cardenas-Morcoso, S. Gimenez, N. Lopez, J. R. Galan-Mascaros, Level Alignment as Descriptor for Semiconductor/Catalyst Systems in Water Splitting: The Case of Hematite/Cobalt Hexacyanoferrate Photoanodes, ChemSusChem. 10 (2017) 4552-4560].

Hence, a thermodynamic driving force to stimulate the photogenerated holes transfer from the surface of hematite to the CoFe-PBA WOC is minimal and ultimately this slows down water oxidation kinetics. As energy levels are not properly matched, tunneling and hopping mechanisms in sub-band-edge states to explain the charge transfer process at hematite/CoFe-PBA interface is proposed.

Although numerous methods to make photoelectrode have beed identified in the past, there still exists a need for a method to make a photoanode with improved PEC efficiency that can overcome the limitations of the art.

In view of the forgoing, one objective of the present disclosure is to describe a CoFe-Prussian blue hematite photoelectrode containing a phosphate ions interfacial drift layer. A further objective of the present disclosure is to provide a method for making the CoFe-prussian blue hematite photoelectrode.

### SUMMARY

In an exemplary embodiment, a photoelectrode is described. The photoelectrode includes a transparent substrate. The photoelectrode further includes a layer of crystalline hematite nanoparticles at least partially covering a surface of the transparent substrate. The photoelectrode further includes a phosphate ions (Pi) interfacial layer coated on a surface of the layer of crystalline hematite nanoparticles. The photoelectrode further includes a plurality of CoFe-Prussian blue analogues (CoFe-PBA) particles uniformly disposed on a surface of the phosphate (Pi) interfacial layer.

In some embodiments, the transparent substrate comprises a glass substrate. In some embodiments, the glass substrate is at least one selected from the group consisting of a fluorine doped tin oxide (FTO) coated glass substrate, a tin doped indium oxide (ITO) coated glass substrate, an aluminum doped zinc oxide (AZO) coated glass substrate, a niobium doped titanium dioxide (NTO) coated glass substrate, an indium doped cadmium oxide (ICO) coated glass substrate, an indium doped zinc oxide (IZO) coated glass substrate, a fluorine doped zinc oxide (FZO) coated glass substrate, a gallium doped zinc oxide (GZO) coated glass substrate, an antimony doped tin oxide (ATO) coated glass substrate, a phosphorus doped tin oxide (PTO) coated glass substrate, a zinc antimonate coated glass substrate, a zinc oxide coated glass substrate, a ruthenium oxide coated glass substrate, a rhenium oxide coated glass substrate, a silver oxide coated glass substrate, and a nickel oxide coated glass substrate.

In some embodiments, the transparent substrate is an FTO coated glass substrate.

In some embodiments, the layer of crystalline hematite nanoparticles has an average thickness of 100 to 1000 nanometers (nm).

In some embodiments, the crystalline hematite nanoparticles are in the form of nanorods having an average diameter of 50 to 150 nm, and an average length of 100 to 800 nm.

In some embodiments, the crystalline hematite nanoparticles are in the form of nanorods having an average diameter of 80 to 120 nm, and an average length of 350 to 550 nm.

In some embodiments, the Pi interfacial layer has an average thickness of 1 to 20 nm.

In some embodiments, the Pi interfacial layer has an average thickness of 5 to 10 nm.

In some embodiments, the Pi interfacial layer containing phosphate ions selected from the group consisting of HPO₄⁻², H₂PO₄⁻², PO₄⁻³, H₃PO₃⁻², HPO₃⁻², H₂PO₃⁻², and PO₃⁻³.

In some embodiments, the particles of CoFe-PBA are in the form of nanocubes having an average edge length of 5 to 20 nm.

In some embodiments, the photoelectrode has a photocurrent density of 1 to 2 milliampere per square centimeter (mA/cm²) at a potential of 1.23 V_{RHE}. The photoelectrode further has an incident photon-to-current conversion efficiency (IPCE) up to 40% at 430 nm wavelength.

In some embodiments, the photoelectrode has a photocurrent density at 1.23 V_{RHE} that is at least 1-fold greater compared to a second photoanode without the CoFe-PBA particles disposed Pi interfacial layer, when incorporated into a photoelectrochemical cell for electrolysis of water into oxygen.

In some embodiments, the photocurrent density is increased by 0.4 to 1 mA/cm² at 1.23 V_{RHE}.

In an exemplary embodiment, a method of making the photoelectrode is described. The method includes immersing a transparent substrate in a first solution containing FeCl₃ and heating to form a β-FeOOH film on a surface of the transparent substrate. The transparent substrate is an FTO coated glass substrate. The method further includes heating and calcining the β-FeOOH film at a temperature of at least 800 degrees Celsius (° C.) to form a crystalline hematite film. The method further includes immersing the crystalline hematite film in a second solution containing phosphate ions (Pi) to form a crude Pi modified hematite film. The method further includes removing the transparent substrate having the crude Pi modified hematite film from the second solution and heating the transparent substrate having the crude Pi modified hematite film at a temperature of at least 300° C. to form a Pi modified hematite film. The method further includes sequentially dipping and drying the Pi modified hematite film in a third solution containing a ferricyanide salt and a fourth solution containing a cobalt salt to form a CoFe/Pi modified hematite film on the surface of the transparent substrate.

In some embodiments, the phosphate ions are selected from the group consisting of HPO₄⁻², H₂PO₄⁻², PO₄⁻³, H₃PO₃, HPO₃⁻², H₂PO₃⁻², and PO₃⁻³.

In some embodiments, the phosphate ions are present in the second solution at a concentration of 0.1 to 1 molar (M), and the second solution has a pH value in a range of 4 to 8.

In some embodiments, the ferricyanide salt includes ferricyanide and positively charged counter ions. The positively charged counter ions are selected from the group consisting of alkaline earth metal ions, alkali metal ions, quaternary ammonium ions having a formula of NR4*, with R being the same or various alkyl or aryl groups.

In some embodiments, the cobalt salt includes cobalt sulfate, cobalt acetate, cobalt citrate, cobalt iodide, cobalt chloride, cobalt perchlorate, cobalt nitrate, cobalt phosphate, cobalt triflate, cobalt bis(trifluoromethanesulfonyl)imide, cobalt tetrafluoroborate, cobalt bromide, and/or a hydrate thereof.

In some embodiments, the heating the crude Pi modified hematite film after being removed from the second solution is carried out for at least 30 minutes at a temperature of at least 300° C.

In some embodiments, a method of photoelectrochemical (PEC) water splitting includes irradiating a photochemical cell including the photoelectrode and water with sunlight to form hydrogen and oxygen.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic flow diagram of a method of making a photoelectrode, according to certain embodiments of the present disclosure;

FIG. 2 is a Bode plot for bare hematite (BH), Pi-modified hematite (P-H), and CoFe Prussian blue analogue/Pi-modified (CoFe-PBA/P-H) electrodes measured at potential of 1.0 volts (V_{RHE}), according to certain embodiments of the present disclosure;

FIG. 3A is a cyclic voltammetry (CV) curve recorded at various scan rates (i.e. 10, 20, 30, 40, and 50 millivolts per second mV/s) for the BH electrode in dark, according to certain embodiments of the present disclosure;

FIG. 3B is a CV curve recorded at the various scan rates (i.e., 10, 20, 30, 40, and 50 mV/s) for the Pi-H electrode in the dark, according to certain embodiments of the present disclosure;

FIG. 3C is a CV curve recorded at the various scan rates (i.e., 10, 20, 30, 40, and 50 mV/s) for the CoFe-PBA/Pi-H electrode in the dark, according to certain embodiments of the present disclosure;

FIG. 3D represents average capacitive current against the scan rates for the BH, Pi-H, and CoFe-PBA/Pi-H electrodes, according to certain embodiments of the present disclosure;

FIG. 4 is a graph depicting Bragg-Brentano X-ray diffraction (XRD) diffraction pattern of fluorine doped tin oxide (FTO) film, the BH, Pi-H, and CoFe-PBA/Pi-H films, according to certain embodiments of the present disclosure;

FIG. 5 is Raman spectra of the BH, Pi-H, and CoFe-PBA/Pi-H films, according to certain embodiments of the present disclosure;

FIG. 6A is a scanning electron microscope (SEM) micrograph of as-grown β-FeOOH akageneite, according to certain embodiments of the present disclosure;

FIG. 6B is a SEM micrograph of the BH, according to certain embodiments of the present disclosure;

FIG. 6C is a SEM micrograph of the P-H, according to certain embodiments of the present disclosure;

FIG. 6D is a SEM micrograph of the CoFe-PBA/Pi-H, according to certain embodiments of the present disclosure;

FIG. 7A is an energy dispersive X-Ray analysis (EDX) mapping of the BH film on the FTO substrate, according to certain embodiments of the present disclosure;

FIG. 7B is the EDX spectrum of the BH film on the FTO substrate, according to certain embodiments of the present disclosure;

FIG. 7C is the elemental mapping of oxygen, according to certain embodiments of the present disclosure;

FIG. 7D is the elemental mapping of iron, according to certain embodiments of the present disclosure;

FIG. 8A is an EDX mapping of the Pi-H film on the FTO substrate, according to certain embodiments of the present disclosure;

FIG. 8B is the EDX spectrum of the Pi-H film on the FTO substrate, according to certain embodiments of the present disclosure;

FIG. 8C is the elemental mapping of Fe, according to certain embodiments of the present disclosure;

FIG. 8D is the elemental mapping of P, according to certain embodiments of the present disclosure;

FIG. 8E is the elemental mapping of O, according to certain embodiments of the present disclosure;

FIG. 9A is an EDX mapping of the CoFe-PBA/Pi-H film on the FTO substrate, according to certain embodiments of the present disclosure;

FIG. 9B is the EDX spectrum of the CoFe-PBA/Pi-H film on the FTO substrate, according to certain embodiments of the present disclosure;

FIG. 9C is the elemental mapping of Fe, according to certain embodiments of the present disclosure;

FIG. 9D is the elemental mapping of P, according to certain embodiments of the present disclosure;

FIG. 9E is the elemental mapping of O, according to certain embodiments of the present disclosure;

FIG. 9F is the elemental mapping of C, according to certain embodiments of the present disclosure;

FIG. 9G is the elemental mapping of Co, according to certain embodiments of the present disclosure;

FIG. 9H is the elemental mapping of N, according to certain embodiments of the present disclosure;

FIG. 10 is a graph depicting low-resolution X-ray photoelectron spectroscopy (XPS) spectra of the BH, Pi-H, and CoFe-PBA/Pi-H films, according to certain embodiments of the present disclosure;

FIG. 11A is a graph depicting a high-resolution XPS (HR-XPS) spectrum of P 2p core-levels in the BH, Pi-H and CoFe-PBA/Pi-H films, according to certain embodiments of the present disclosure;

FIG. 11B is a graph depicting an HR-XPS spectrum of Fe 2p core-levels in the BH, Pi-H and CoFe-PBA/Pi-H films, according to certain embodiments of the present disclosure;

FIG. 11C is a graph depicting an HR-XPS spectrum of Co 2p core-levels in the BH, Pi-H and CoFe-PBA/Pi-H films, according to certain embodiments of the present disclosure;

FIG. 11D is a graph depicting an XPS spectrum of the Co 2p for CoFe-PBA powder, according to certain embodiments of the present disclosure;

FIG. 11E is a graph depicting an HR-XPS spectrum of N 1s core-levels in the BH, Pi-H and CoFe-PBA/Pi-H films, according to certain embodiments of the present disclosure;

FIGS. 11F-G are graphs depicting HR-XPS spectra of O 1s core-levels in the BH, Pi-H and CoFe-PBA/Pi-H films, according to certain embodiments of the present disclosure;

FIG. 11H is a graph depicting an XPS spectrum of the O 1s for the BH photoanode, according to certain embodiments of the present disclosure;

FIGS. 12-15 are graphs depicting current-voltage characteristic (I-V) curves for photoelectrochemical water oxidation on the BH and Pi-H photoanodes at various conditions, measured at standard test conditions (STCs) from 1.0 mole per liter (mol/L) NaOH solution, according to certain embodiments of the present disclosure;

FIG. 16 is a graph depicting I-V curves for the photoelectrochemical water oxidation on the Pi-H and CoFe-PBA/Pi-H photoanodes measured at the STC from the 1.0 mol/L NaOH solution, according to certain embodiments of the present disclosure;

FIG. 17A is a graph depicting linear sweep voltammetry (LSC) curves of the BH, Pi-H, CoFe-PBA/BH and CoFe-PBA/Pi-H photoanodes, according to certain embodiments of the present disclosure;

FIG. 17B is a graph depicting applied bias photon-to-current conversion efficiency (ABPE) percentage of the BH, Pi-H, CoFe-PBA/BH and CoFe-PBA/Pi-H photoanodes, according to certain embodiments of the present disclosure;

FIG. 17C is a graph depicting long-term stability test of the CoFe-PBA/Pi-H photoanode measured at 1.23 V_{RHE}, according to certain embodiments of the present disclosure;

FIG. 17D is a graph depicting incident photon-to-current conversion efficiency (IPCE) percentage of the BH, Pi-H and CoFe-PBA/Pi-H photoanodes, according to certain embodiments of the present disclosure;

FIG. 18A is a graph depicting diffuse reflectance spectra of the BH, Pi-H, and CoFe-PBA/Pi-H films, according to certain embodiments of the present disclosure;

FIG. 18B is Tauc plot of the BH, Pi-H, and CoFe-PBA/Pi-H films, according to certain embodiments of the present disclosure;

FIG. 19A is a graph depicting transient photocurrent (TPC) response for the BH, Pi-H, and CoFe-PBA/Pi-H measured at 1.23 V_{RHE} under the STC, according to certain embodiments of the present disclosure;

FIG. 19B is a graph depicting anodic transient decay times for the BH, Pi-H, and CoFe-PBA/Pi-H measured at 1.23 V_{RHE} under the STC, according to certain embodiments of the present disclosure;

FIG. 20 is a graph depicting I-V curves for the photoelectrochemical water oxidation on the BH, Pi-H, and CoFe-PBA/Pi-H photoanodes measured under chopped simulated solar light (1 sun, AM 1.5 G) from the 1.0 mol/L NaOH solution, according to certain embodiments of the present disclosure;

FIG. 21A is a graph depicting open circuit potential (OCP) of the BH, Pi-H, and CoFe-PBA/Pi-H photoanodes, according to certain embodiments of the present disclosure;

FIG. 21B is a graph depicting Mott-Schottky (M-S) plots of the BH, Pi-H, and CoFe-PBA/Pi-H photoanodes at 1.0 kilohertz (kHz), according to certain embodiments of the present disclosure;

FIG. 22A is a graph depicting Mott-Schottky plots of the BH electrode measured at various frequencies in the dark at 1.23 V vs reversible hydrogen electrode (RHE) in the 1.0 mol/L NaOH aqueous solution, according to certain embodiments of the present disclosure;

FIG. 22B is a graph depicting Mott-Schottky plots of the P-H electrode measured at various frequencies in the dark at 1.23 V vs RHE in the 1.0 mol/L NaOH aqueous solution, according to certain embodiments of the present disclosure;

FIG. 22C is a graph depicting Mott-Schottky plots of the CoFe-PBA/Pi-H electrode measured at various frequencies in the dark at 1.23 V vs RHE in the 1.0 mol/L NaOH aqueous solution, according to certain embodiments of the present disclosure;

FIG. 23 is a graph depicting fitted Nyquist plots of the BH, Pi-H, CoFe-PBA/B-H and CoFe-PBA/Pi-H photoanodes, according to certain embodiments of the present disclosure;

FIG. 24 is an exemplary equivalent circuit used for fitting Potentiostatic electrochemical impedance spectroscopy (PEIS) spectra, according to certain embodiments of the present disclosure;

FIG. 25 is a graph depicting Fitted charge transfer resistance (R_{ct}) of the BH, Pi-H, and CoFe-PBA/Pi-H photoanodes measured at 0.9 V_{RHE} under the STC, according to certain embodiments of the present disclosure;

FIG. 26 is a graph depicting typical normalized intensity-modulated photocurrent spectroscopy (IMPS) response for the BH measured at 1.0 V_{RHE}, according to certain embodiments of the present disclosure;

FIG. 27A is a graph depicting IMPS response of the BH electrode as a function of the applied potentials, according to certain embodiments of the present disclosure;

FIG. 27B is a graph depicting IMPS response of the PI-H electrode as a function of the applied potentials, according to certain embodiments of the present disclosure;

FIG. 27C is a graph depicting IMPS response of the CoFe-PBA/Pi-H electrode as a function of the applied potentials, according to certain embodiments of the present disclosure;

FIG. 28A is a graph depicting apparent rate constants of charge recombination (k_{rec}) of the BH, Pi-H, and CoFe-PBA/Pi-H electrodes as a function of the applied potentials, according to certain embodiments of the present disclosure;

FIG. 28B is a graph depicting apparent rate constants of transfer (kₜᵣ) of the BH, Pi-H, and CoFe-PBA/Pi-H electrodes as a function of the applied potentials, according to certain embodiments of the present disclosure;

FIG. 28C is a graph depicting apparent rate constants of charge transfer efficiency (let %) of the BH, Pi-H, and CoFe-PBA/Pi-H electrodes as a function of the applied potentials, according to certain embodiments of the present disclosure;

FIG. 29A is a graph depicting solar and integrated photocurrent densities of the BH, Pi-H, and CoFe-PBA/Pi-H photoanodes, according to certain embodiments of the present disclosure;

FIG. 29B is a graph depicting density-voltage (J-V) curves measured in an aqueous solution of NaOH with (dashed line) and without (solid lines) Na₂SO₃, of the BH, Pi-H, and CoFe-PBA/Pi-H photoanodes, according to certain embodiments of the present disclosure;

FIG. 29C is a graph depicting charge separation efficiency (ηₛₑₚ) of the BH, Pi-H, and CoFe-PBA/Pi-H photoanodes, according to certain embodiments of the present disclosure;

FIG. 29D is a graph depicting charge transfer efficiency (η_{cat}) of the BH, Pi-H, and CoFe-PBA/Pi-H photoanodes, according to certain embodiments of the present disclosure;

FIG. 30A shows density functional theory (DFT) slab models used for electrostatic potential (eV) calculations, according to certain embodiments of the present disclosure;

FIG. 30B is a graph depicting the electrostatic potential of BH and BH-Pi slabs, according to certain embodiments of the present disclosure;

FIG. 31A is an exemplary energetic scheme for the BH illustrating surface recombination rate (k_{rec}) and charge transfer rate (kₜᵣ) at hematite/Pi/CoFe-PBA interfaces, according to certain embodiments of the present disclosure;

FIG. 31B is an exemplary energetic scheme for the P-H illustrating surface recombination rate (k_{rec}) and charge transfer rate (kₜᵣ) at the hematite/Pi/CoFe-PBA interfaces, according to certain embodiments of the present disclosure; and

FIG. 31C is an exemplary energetic scheme for the CoFe-PBA/Pi-H illustrating surface recombination rate (k_{rec}) and charge transfer rate (kₜᵣ) at the hematite/Pi/CoFe-PBA interfaces, according to certain embodiments of the present disclosure.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

Aspects of the present disclosure are directed to a photoelectrode with improved water splitting efficiency. As described herein, the photoelectrode is a designed photoanode with a phosphate ions (Pi) interfacial layer to attract and hold photogenerated holes at a surface and with an oxygen evolution reactions (OER) catalyst such as CoFe-PBA to accomplish water oxidation process at an adequate rate. The photoelectrode exhibits low cost, high stability, suitable band structure, and excellent light-harvesting properties, thereby circumventing drawbacks such as high manufacturing cost, and low photoelectrochemical (PEC) water-splitting efficiency of the prior art.

According to an aspect of the present disclosure, a photoelectrode is described. The photoelectrode includes a transparent substrate. The transparent substrate may be a glass substrate.

In some embodiments, the glass substrate is selected from a fluorine doped tin oxide (FTO) coated glass substrate, a tin-doped indium oxide (ITO) coated glass substrate, an aluminum doped zinc oxide (AZO) coated glass substrate, a niobium doped titanium dioxide (NTO) coated glass substrate, an indium doped cadmium oxide (ICO) coated glass substrate, an indium doped zinc oxide (IZO) coated glass substrate, a fluorine doped zinc oxide (FZO) coated glass substrate, a gallium doped zinc oxide (GZO) coated glass substrate, an antimony doped tin oxide (ATO) coated glass substrate, a phosphorus doped tin oxide (PTO) coated glass substrate, a zinc antimonate coated glass substrate, a zinc oxide coated glass substrate, a ruthenium oxide coated glass substrate, a rhenium oxide coated glass substrate, a silver oxide coated glass substrate, and a nickel oxide coated glass substrate. In a preferred embodiment, the glass substrate is the FTO coated glass substrate. Optionally, the glass substrate may be replaced by a titanium plate or a copper plate.

The photoelectrode further includes a layer of crystalline α-Fe₂O₃ (hematite) nanoparticles at least partially covering the surface of the transparent substrate. In an embodiment, the layer of crystalline α-Fe₂O₃ nanoparticles may cover the whole surface of the transparent substrate. In an embodiment, the layer of crystalline α-Fe₂O₃ nanoparticles may cover at least 5% of a surface area of the transparent substrate based on a total surface area, preferably at least 10%, preferably at least 30%, preferably at least 50%, preferably at least 70%, preferably at least 90%, based on the total surface area of the transparent substrate. Other ranges are also possible.

The crystalline α-Fe₂O₃ nanoparticles exhibit an environmentally benign nature, stability in water at a wide range of pH (4-14), abundantly available in earth crust (6.3 wt. %), and valence band potential of the crystalline α-Fe₂O₃ nanoparticles matches the thermodynamic requirements for water oxidation. The crystalline α-Fe₂O₃ nanoparticles are a semiconductor material which may absorb light within a certain wavelength range and which has the potential for photoelectrochemical research into solar energy conversion. In some embodiments, the layer of crystalline hematite nanoparticles has an average thickness of 100 to 1000 nanometers (nm), preferably 200 to 900 nm, preferably 300 to 700 nm, or more preferably 400 to 600 nm. In some embodiments, the crystalline hematite nanoparticles are in the form of nanorods having an average diameter of 50 to 150 nm, preferably 60 to 140 nm, preferably 70 to 130 nm, preferably 80 to 120 nm, or more preferably in a range of 90 to 100 nm. In some further embodiments, the crystalline hematite nanoparticles are in the form of nanorods having an average length of 100 to 800 nm, preferably 200 to 700 nm, preferably 300 to 600 nm, or more preferably an average length of 350 to 550 nm. Other ranges are also possible.

As used herein, the term “hematite” generally refers to an iron oxide semiconductor material containing different polymorphs, for example, α-Fe₂O₃, γ-Fe₂O₃, β-FeO. In another embodiment, the α-Fe₂O₃ semiconductor is mesostructured. The α-Fe₂O₃ semiconductor has a high surface area. In some embodiments, semiconductors such as titanium dioxide, cobalt-ion, zinc oxide, and W-doped BiVO₄ may also be used. The listed examples are generally inorganic in character. In one embodiment, the semiconductor may include a group IV semiconductor having a formula selected from the group consisting of binary, ternary, and quaternary. In a further embodiment, the group IV semiconductor further includes ions selected from the group consisting of cations and anions. In one embodiment, the semiconductor is an n-type semiconductor.

The photoelectrode further includes a phosphate ions (Pi) interfacial layer coated on a surface of the layer of crystalline hematite nanoparticles. In some embodiments, the Pi interfacial layer has an average thickness of 1 to 20 nm, preferably 3 to 17 nm, preferably 5 to 15 nm, preferably 7 to 13 nm, or more preferably 9 to 11 nm. In some further embodiments, the Pi interfacial layer includes phosphate ions selected from the group consisting of HPO₄⁻², H₂PO₄⁻², PO₄⁻³, H₃PO₃, HPO₃⁻², H₂PO₃⁻², and PO₃⁻³. In a preferred embodiment, the phosphate ions may come from one or more salts selected from the group consisting of Na₃PO₄, Na₂HPO₄, NaH₂PO₄.

### Other Ranges are Also Possible

The photoelectrode further includes a plurality of CoFe-Prussian blue analogues (CoFe-PBA) particles uniformly disposed on a surface of the phosphate (Pi) interfacial layer. In some embodiments, the particles of CoFe-PBA are in the form of nanocubes having an average edge length of 5 to 20 nm, preferably 7.5 to 17.5 nm, or more preferably 10 to 15 nm. Other ranges are also possible.

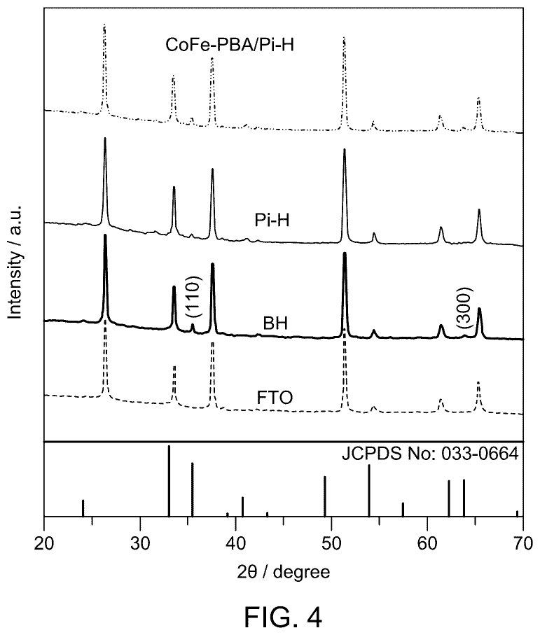

The crystalline structures of the FTO, bare hematite (BH), Pi-modified hematite (P-H), and CoFe-Prussian blue analogue/Pi-modified (CoFe-PBA/P-H) films are characterized by X-ray diffraction (XRD), respectively. In some embodiments, the XRD patterns are collected in a Rigaku X-ray diffractometer equipped with a Cu-Kα radiation source (λ=0.15406 nm) for a 2θ range extending between 10 and 80°, preferably 20 and 70°, further preferably 30 and 60° at an angular rate of 0.005 to 0.04° s⁻¹, preferably 0.01 to 0.03° s⁻¹, or even preferably 0.02° s⁻¹. In some embodiments, the CoFe-PBA/P-H film has a first intense peak with a 2 theta (θ) value in a range of 20 to 30° in an X-ray diffraction (XRD) spectrum, as depicted in FIG. 4. In some embodiments, the CoFe-PBA/P-H film has at least a second intense peak with a 2 theta (θ) value in a range of 30 to 450 in the X-ray diffraction (XRD) spectrum, as depicted in FIG. 4. In some further embodiments, the CoFe-PBA/P-H film has a third intense peak with a 2 theta (θ) value in a range of 50 to 55° in the X-ray diffraction (XRD) spectrum, as depicted in FIG. 4. Other ranges are also possible.

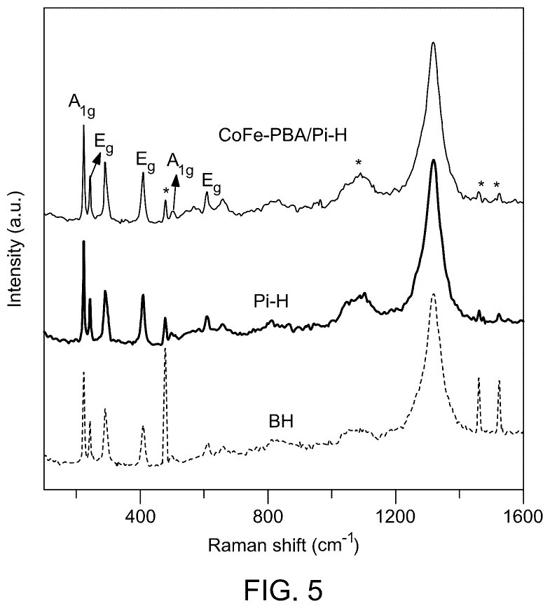

Additionally, the structures of BH, Pi-H, and CoFe-PBA/Pi-H films are also characterized by the Raman spectroscopy as depicted in FIG. 5. Raman spectra of the CoFe-PBA/Pi-H over the range of 100 to 1700 cm⁻¹ were obtained by using a HORIBA Scientific LabRAM HR Evolution Raman spectrometer. A He-Ne laser source working at 17 mW and 532 nm excitation wavelength with 100% laser power was used for the measurements. An acquisition time of 25 s with 2 accumulations was set for the Raman spectra collection for bare and modified hematite films. In some embodiments, the CoFe-PBA/P-H film has at least one intense peak in a range of 200 to 600 cm⁻¹. In some further embodiments, the CoFe-PBA/P-H film has at least one intense peak in a range of 800 to 1600 cm⁻¹. Other ranges are also possible.

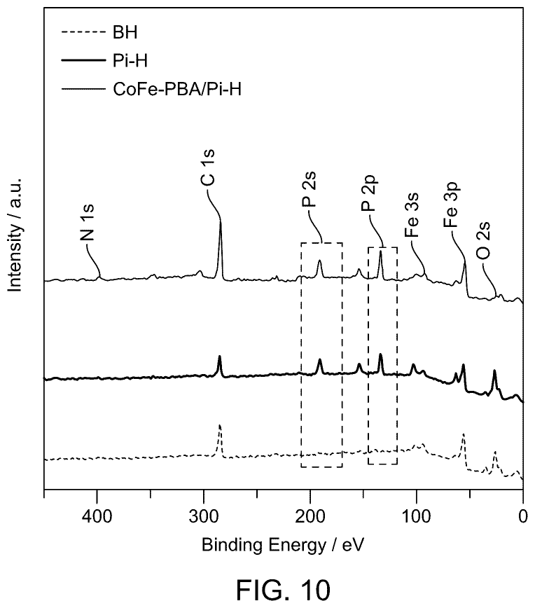

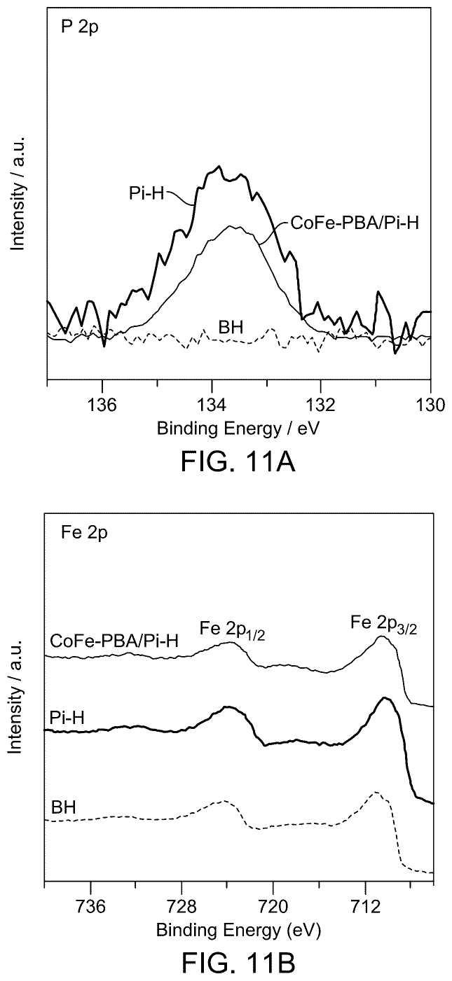

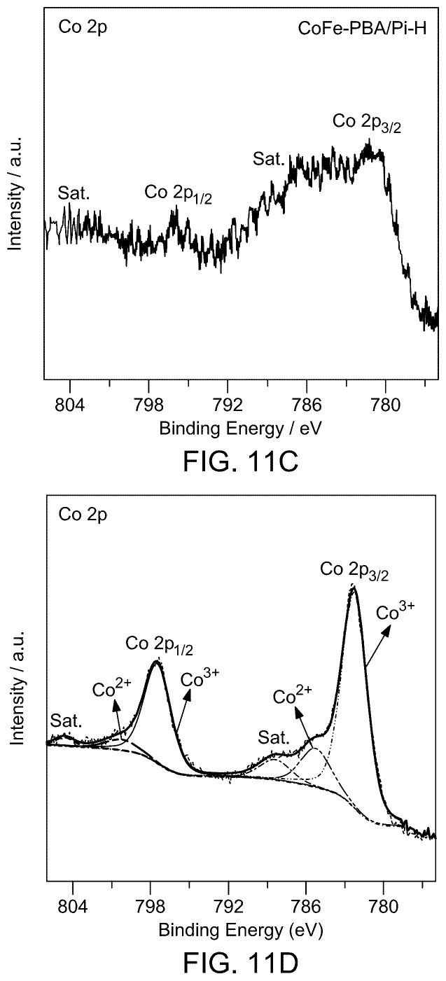

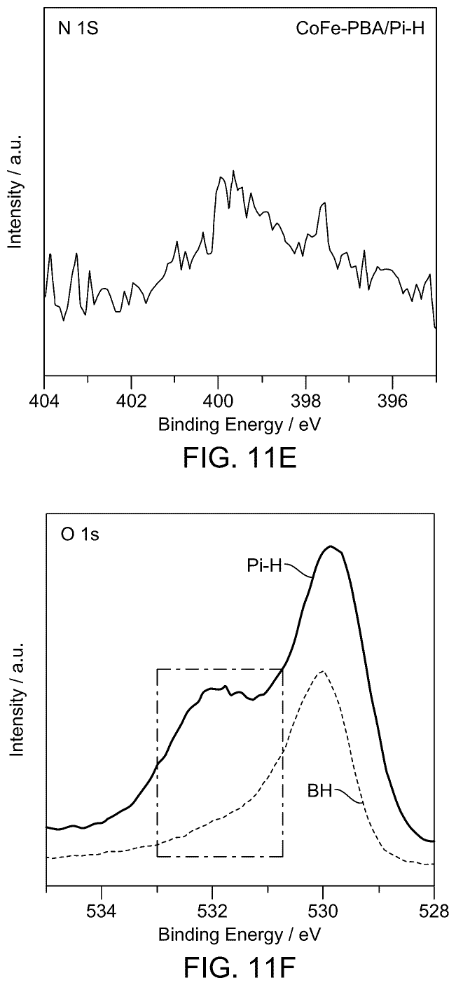

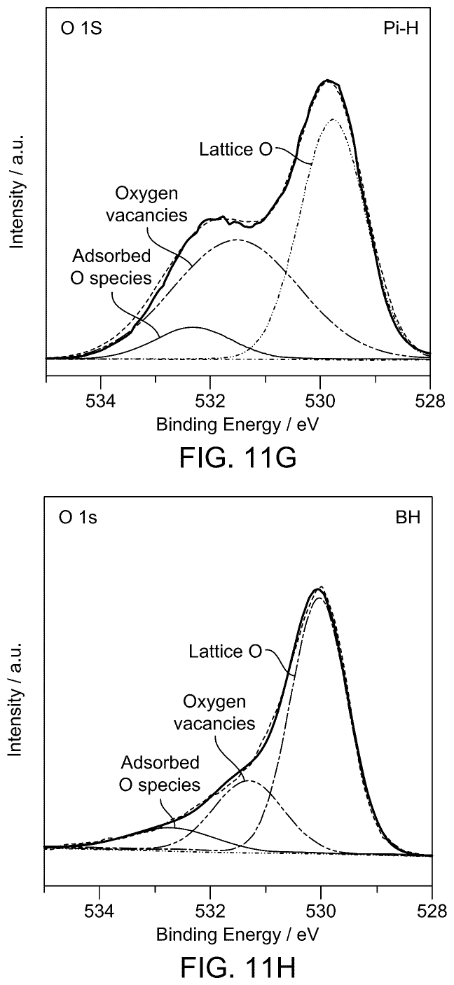

Even further, the surface chemistry of BH, Pi-H, and CoFe-PBA/Pi-H films is investigated by the X-ray photoelectron spectroscopy (XPS) analysis as depicted in FIGS. 10 to 11. The XPS spectra were obtained by using an ESCALAB™ Xi™ X-ray photoelectron spectrometer (Thermo Scientific), equipped with a monochromatic micro-focused Al Kα X-ray source. The XPS spectra were calibrated by taking the C is peak at 284.8 eV as a reference.

In some embodiments, the photoelectrochemical performance of the photoelectrode was assessed in an aqueous solution containing 0.1 M NaOH, preferably 0.5 M, preferably 1 M, preferably 1.5 M, or more preferably 2 M NaOH, under reference spectra for sunlight at ground-level (AM1.5G). Linear sweep voltammetry (LSV) and chronoamperometry (CA) procedures were used to measure the continuous and chopped photocurrent. In some embodiments, the photoelectrode has a photocurrent density of 1 to 2 mA cm⁻² at a potential of 1.23 V_{RHE}, preferably 1.1 to 1.9 mA cm⁻², preferably 1.2 to 1.8 mA cm⁻², preferably 1.3 to 1.7 mA cm⁻², or more preferably 1.4 to 1.6 mA cm⁻² at the potential of 1.23 V_{RHE}. In some preferred embodiments, the photocurrent density of the photoelectrode is increased by 0.4 to 1 mA cm⁻² at 1.23 V_{RHE}, preferably 0.5 to 0.9 mA cm⁻², preferably 0.6 to 0.8 mA cm⁻², or more preferably 0.7 mA cm⁻² at 1.23 V_{RHE}. Other ranges are also possible.

The incident photon-to-current conversion efficiency (IPCE) is used to correlate the discrete efficiency of the cell as a function of wavelength with the short circuit current measurements of cells under one sun illumination. In the present disclosure, the IPCE value at different wavelengths (λ, nm) using a collimated and high-power LEDs (Thorlabs) is calculated by the Equation (3) below:

$$I P C E ( \% ) = \frac{12 \; 40 Jph}{λ {P}_{light}} \cdot x \cdot 100 \qquad ( 3 )$$

In some preferred embodiments, the photoelectrode has an IPCE up to 40% at 430 nm wavelength, preferably up to 35%, preferably up to 30%, preferably up to 25%, or more preferably up to 20% based on at 430 nm wavelength. In some embodiments, the photoelectrode has a photocurrent density at 1.23 V_{RHE} that is at least 1-fold greater compared to a second photoanode without the CoFe-PBA particles disposed Pi interfacial layer, when incorporated into a photoelectrochemical cell for electrolysis of water into oxygen.

The introduction of the phosphate ions interfacial layer on the surface of the layer of crystalline hematite nanoparticles before loading the plurality of CoFe-Prussian blue analogues can drift and store photogenerated holes at the hematite's surface and hence making the photogenerated holes energetically accessible to transfer to the CoFe-PBA and get involved in the process of water oxidation. Existence of the Pi interfacial layer improves the photocurrent at relative to those of bare hematite (BH), hematite modified with only Pi layer (Pi-H), and hematite modified with only CoFe-PBA (CoFe-PBA/BH), respectively. In an embodiment, the photoelectrode is a photoanode.

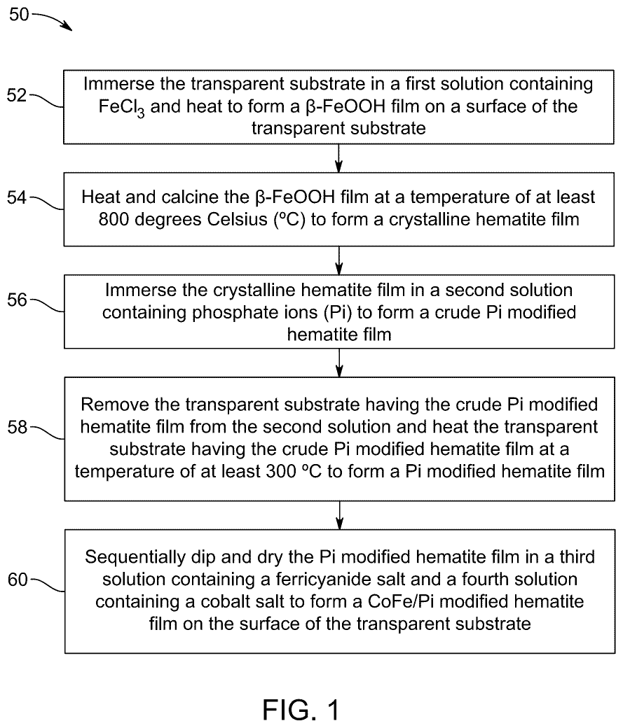

FIG. 1 shows a schematic flow diagram of a method 50 of making the photoelectrode. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes immersing the transparent substrate in a first solution containing FeCl₃ and heating to form a β-FeOOH film on the surface of the transparent substrate. In an embodiment, the first solution may optionally include other ferric salts, such as, ferric sulfate, ferric ammonium oxalate and ferric borate. In some embodiments, the FeCl₃ is present in the first solution at a concentration of 0.05 to 0.5 M, preferably 0.075 to 0.4 M, preferably 0.1 to 0.3 M, preferably 0.125 to 0.2 M, or even more preferably 0.15 M. In some embodiments, the transparent substrate is a glass substrate. In some further embodiments, the glass substrate is selected from the group consisting of an FTO coated glass substrate, an ITO coated glass substrate, an AZO coated glass substrate, an NTO coated glass substrate, an ICO coated glass substrate, an IZO coated glass substrate, an FZO coated glass substrate, a GZO coated glass substrate, an ATO coated glass substrate, a PTO coated glass substrate, a zinc antimonate coated glass substrate, a zinc oxide coated glass substrate, a ruthenium oxide coated glass substrate, a rhenium oxide coated glass substrate, a silver oxide coated glass substrate, and a nickel oxide coated glass substrate. In some preferred embodiments, the glass substrate is the FTO coated glass substrate. Optionally, the glass substrate may be replaced by a titanium plate or a copper plate.

In an embodiment, the β-FeOOH film may be grown on the FTO coated glass substrate by a chemical bath deposition method. As used herein, the term “chemical bath deposition method” generally refers to a method of thin-film deposition (solids forming from a solution or gas), using an aqueous precursor solution. In another embodiment, the β-FeOOH film may be grown on the FTO coated glass substrate by a method known or used in the art. In an embodiment, the heating may be carried out in a domestic oven for 3-9 hours, preferably 4-8 hours, preferably 5-7 hours, or even more preferably 6 hours at around 70-120° C., preferably 80-110° C., preferably 90-100° C., or even more preferably 95° C. In an embodiment, the method 50 further includes quenching by cooling in a cold-water bath, so that the β-FeOOH film may be washed with water and dried naturally. Other ranges are also possible.

At step 54, the method 50 includes heating and calcining the β-FeOOH film at a temperature of at least 800 degrees Celsius (° C.) to form a crystalline hematite film. In some embodiments, the heating may be carried out at a temperature of 300 to 800° C., preferably 350 to 750° C., preferably 400 to 700° C., preferably 450 to 650° C., preferably 500 to 600° C., or more preferably 550° C. for at least 1 hour, at least 3 hours, at least 5 hours, at least 7 hours, and no more than 9 hours, no more than 7 hours, no more than 5 hours, no more than 3 hours. In some further embodiments, the calcining may be carried out at a temperature of at least 800° C., at least 850° C., at least 900° C., at least 950° C., at least 1000° C., at least 1200° C., at least 1400° C., or at least 1600° C. for 1 to 60 minutes, preferably 5 to 45 minutes, preferably 10 to 30 minutes, or more preferably 20 minutes. In an embodiment, the crystalline hematite film formed after heating and calcining has an average thickness of 100 to 1000 nanometers (nm), more preferably, 500 to 800 nm. In another embodiment, particles of the crystalline hematite film are in the form of nanorods having an average diameter of 50 to 150 nm, and more preferably in a range of 80 to 120 nm, and an average length of 100 to 800 nm, and more preferably an average length of 350 to 550 nm. Other ranges are also possible.

At step 56, the method 50 includes immersing the crystalline hematite film in a second solution including the phosphate ions (Pi) to form a crude Pi modified hematite film. In some embodiments, the phosphate ions are present in the second solution at a concentration of 0.1 to 1 molar (M), preferably 0.2 to 0.9 M, preferably 0.3 to 0.8 M, preferably 0.4 to 0.7 M, or more preferably in a range of 0.5 to 0.6 M, and a pH value in a range of 4 to 8, and more preferably in a range of 5-7. In some embodiments, the phosphate ions are selected from the group consisting of HPO₄⁻², H₂PO₄⁻², H₃PO₃, HPO₃⁻², H₂PO₃⁻², and PO₃⁻³. In a preferred embodiment, the phosphate ions may come from at selected one or more salts selected from the group consisting of Na₃PO₄, Na₂HPO₄, NaH₂PO₄. In some embodiments, the crystalline hematite film is in contact with the second solution for 5 to 180 minutes, preferably 15 to 150 minutes, preferably 30 to 120 minutes, or more preferably 45 to 90 minutes. Other ranges are also possible.

At step 58, the method 50 includes removing the transparent substrate having the crude Pi modified hematite film from the second solution, soaking in water to remove unbound phosphate groups and heating the transparent substrate having the crude Pi modified hematite film at a temperature selected from a range of 300-400° C., more preferably 300° C. to form a Pi modified hematite film. In an embodiment, the heating is carried out for a time interval selected from a range of 30-150 minutes to enhance the adhesion of the anchored phosphate layer on the surface of hematite. In an embodiment, the heating is carried out for at least 15 minutes, at least 30 minutes, at least 60 minutes, or at least 120 minutes at a temperature of at least 300° C., at least 350° C., at least 400° C., or at least 500° C. Other ranges are also possible.

At step 60, the method 50 includes sequentially dipping and drying the Pi modified hematite film in a third solution containing a ferricyanide salt, and a fourth solution containing a cobalt salt to form a CoFe/Pi modified hematite film on the surface of the transparent substrate. The ferricyanide salt includes ferricyanide and positively charged counter ions. In some embodiments, the positively charged counter ions are selected from the group consisting of alkaline earth metal ions, alkali metal ions, quaternary ammonium ions having a formula of NR4⁺, with R being the same or various alkyl or aryl groups. In an embodiment, the ferricyanide salt is potassium hexacyanoferrate (III) (K₃[Fe(CN)₆]). In some embodiments, the ferricyanide salt is present in the third solution at a concentration of 1 to 100 millimolar(mM), preferably 5 to 70 mM, preferably 10 to 50 mM, preferably 15 to 30 mM, or more preferably 20 mM. In some further embodiments, the Pi modified hematite film is in contract with the third solution of 1 to 60 minutes, preferably 5 to 45 minutes, preferably 10 to 30 minutes, or more preferably 15 minutes. Other ranges are also possible.

In some embodiments, the cobalt salt includes cobalt sulfate, cobalt acetate, cobalt citrate, cobalt iodide, cobalt chloride, cobalt perchlorate, cobalt nitrate, cobalt phosphate, cobalt triflate, cobalt bis(trifluoromethanesulfonyl)imide, cobalt tetrafluoroborate, cobalt bromide, and/or a hydrate thereof. In some preferred embodiments, the cobalt salt may include cobalt borate, cobalt methyl phosphonate, and/or any combination thereof. In a more preferred embodiment, the cobalt salt is Cobalt(II) chloride hexahydrate (CoCl₂·6H₂O). In an embodiment, the ferricyanide salt is potassium hexacyanoferrate (III) (K₃[Fe(CN)₆]). In some embodiments, the cobalt salt is present in the fourth solution at a concentration of 1 to 100 mM, preferably 10 to 80 mM, preferably 20 to 60 mM, preferably 30 to 50 mM, or more preferably 40 mM. In some further embodiments, the Pi modified hematite film is in contract with the fourth solution of 1 to 60 minutes, preferably 5 to 45 minutes, preferably 10 to 30 minutes, or more preferably 15 minutes. Other ranges are also possible.

A method of photoelectrochemical water splitting includes irradiating a photochemical cell including the photoelectrode and water with sunlight to form hydrogen and oxygen. The photoelectrode formed by the process of present disclosure has a photocurrent density of 1 to 2 milliampere per square centimeter (mA/cm²) at a potential of 1.23 V_{RHE}. The photoelectrode further have an incident photon-to-current conversion efficiency (IPCE) up to 40% at 430 nm wavelength. The photoelectrode have a photocurrent density at 1.23 V_{RHE} that is at least 1-fold greater compared to a second photoanode without the CoFe-PBA particles disposed Pi interfacial layer, when incorporated into a photoelectrochemical cell for electrolysis of water into oxygen. The photocurrent density is increased by 0.4 to 1 mA/cm² at 1.23 V_{RHE}.

### EXAMPLES

The following examples describe and demonstrate exemplary embodiments of the method 50 of making the photoelectrode described herein. The examples are provided solely for the purpose of illustration and are not to be construed as limitations of the present disclosure, as many variations thereof are possible without departing from the spirit and scope of the present disclosure.

### Example 1: Fabrication of Bare Hematite (BH) Films

A β-FeOOH akaganeite film was grown on F-doped SnO₂ coated glass substrates (FTO, TEC 7, Sigma-Aldrich) by a chemical bath deposition method. The FTO substrates (1.0×2.0 cm²) were cleaned and vertically immersed in 15 mL autoclavable vial containing 5 mL of 0.15 M FeCl₃·6H₂O solution. The autoclavable vial was then closed and placed in a domestic oven for 6 h at 95° C. After cooling by quenching in a cold-water bath, the grown akaganeite films were washed with water and dried naturally in an ambient atmosphere. Then, the grown akaganeite films were heat-treated at 550° C. for 1 h and calcined again at 800° C. for 20 minutes to convert the β-FeOOH akaganeite film into crystalline hematite film, also referred to as the BH.

### Example 2: Modification of Hematite Films with Phosphate Ions (Pi) Layer

The BH films were immersed in 0.5 M phosphate buffer at various pH values (i.e., 4.0-7.0) for various periods (i.e., 30-120 minutes). Afterward, the BH films were withdrawn from phosphate buffer solution and soaked in water to remove unbound phosphate groups. The BH films were dried at room temperature and calcined at various temperatures (300-400° C.) for various time intervals (i.e., 30-150 minutes) to enhance the adhesion of anchored phosphate layer on a surface of hematite. Pi-modified hematite films are also referred to as the Pi-H.

### Example 3: Sequential Modification of Pi-H Films with CoFe-PBA

The Pi-H films were further modified with CoFe-PBA WOC. The Pi-H films were sequentially dipped in aqueous solutions of 20 millimolars (mM) K₃[Fe(CN)₆] and 40 mM CoCl₂·6H₂O. The Pi-H films were dipped for 15 minutes in K₃[Fe(CN)₆] solution, then the Pi-H films were soaked in water to remove the unbounded K₃[Fe(CN)₆] and dried at room temperature. The Pi-H films were dipped again for 15 minutes in CoCl₂ aqueous solution, then the Pi-H films were rinsed with water and were dried. The present sequence was repeated multiple times (i.e., from 2 to 8 times) to optimize the PEC water oxidation performance. The modified Pi-H films are also referred to as the CoFe-PBA/Pi-H.

### Example 4: PEC and Spectroscopic Measurements

The PEC, electrochemical impedance spectroscopy (EIS), and intensity-modulated photocurrent spectroscopy (IMPS) experiments were carried out using PEC workstation methods described in the art. The BH, Pi-H, and CoFe-PBA/Pi-H films were used as photoanodes and 1.0 M NaOH was used as an electrolyte. The counter and reference electrodes were Pt wire and Hg/HgO (1.0 M NaOH), respectively. Silicon reference cell (Accreditation Board for Engineering and Technology (ABET) technologies) was used to calibrate and adjust the simulated light intensity of the 1002 SunLite™ Solar Simulators (ABET technologies) to 1.0 sun (100 milliwatt per square centimetre (mW/cm²). Equation (1) was used to convert all measured potentials against Hg/HgO to a reversible hydrogen electrode (RHE) scale (E_{Hg/HgO}^{O} (1.0 M NaOH)=0.118 V, pH=13.6).

E_{RHE}=E_{Hg/HgO}+0.059pH+E_{Hg/HgO}^{O} (1)

Equation (2) was used to calculate the applied bias photon-to-current conversion efficiency (ABPE) at various applied potentials (Vₐₚₚ. vs Pt).

$$A B P E = \frac{{J}_{ph} ( 1.23 - {V}_{app .} ) * 100}{{P}_{light}} \qquad ( 2 )$$

where the photocurrent density (Jₚₕ Ma/cm²) was measured in two-electrode cell configuration and P_{ligh} is the light intensity at STC (100 mW/cm²).

Equation (3) was used to calculate the IPCE at various wavelengths (λ, nm) using a collimated and high-power light-emitting diodes (LEDs) (Thorlabs).

$$I P C E ( \% ) = \frac{12 \; 40 Jph}{λ {P}_{light}} \cdot x \cdot 100 \qquad ( 3 )$$

The Jₚₕ (mA/cm²) at 1.23 V_{RHE} for the BH, Pi-H, and CoFe-PBA/Pi-H films were measured using a chronoamperometry technique. Light intensities of the LEDs were determined using a calibrated Si photodiode (FDS100-CAL, Thorlabs).

IMPS responses were measured at various potentials using Autolab PGSTAT302N workstation equipped with FRA32M module, DAC164 LED driver, and Triple LED array (470 nm). The IMPS responses allowed modulation of incident light and measurement of the modulated photocurrent responses at various frequencies (10 kilohertz (kHz)-0.1 Hz).

The EIS experiments were executed from 100 kHz to 0.1 Hz at an amplitude of 10 millivolts (mV). Mott-Schottky plots were constructed at a frequency (f) equal to 0.1, 1.0, or 10 kHz using a resistor and a capacitor connected in series. Space charge layer capacitance (C_{sc}) was calculated from equation (4).

$$Im ( Z ) = \frac{- 1}{2 π f {C}_{SC}} \qquad ( 4 )$$

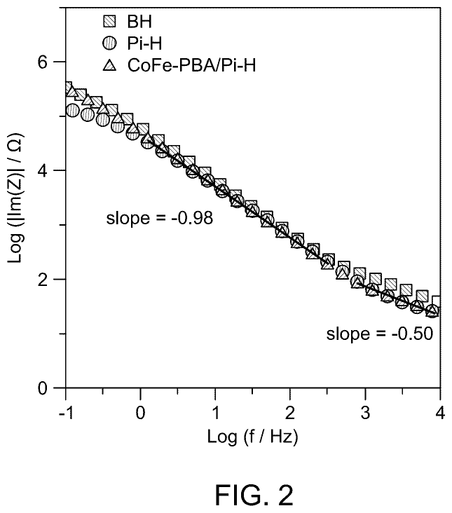

From Equation. 4, a graph between log (Im(Z)) vs. log (f) gives a straight line and a slope is equal to −1 in pure capacitance region as shown in FIG. 2.

### Example 5: Real Surface Area (Aᵣₑₐₗ) Measurements

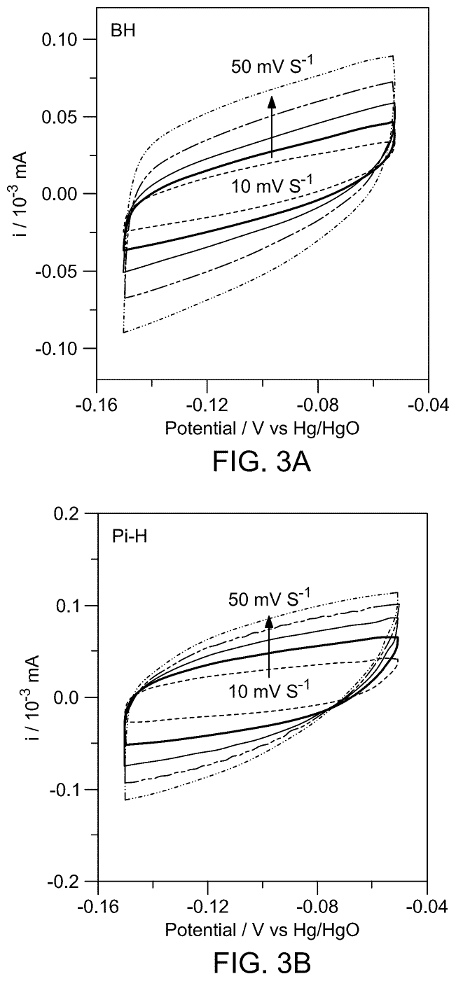

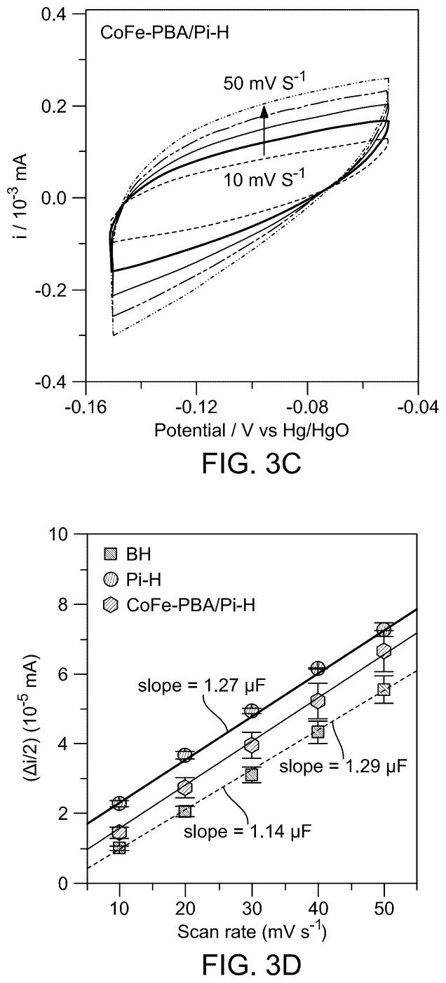

Real surface area (Aᵣₑₐₗ) was determined from the analysis of cyclic voltammograms (CVs) collected at various scan rates in a non-faradaic region. As used herein, the term ‘non-faradaic region’ referred to the region close to open circuit potential in the dark, OCP_{dark}). FIGS. 3A-3C show the CVs of BH, Pi-H, and CoFe-PBA/Pi-H electrodes. Assuming pure capacitive current, a plot of current vs. scan rate gives a straight line, as shown in FIG. 3D. The slope of the straight line is equivalent to double-layer capacitance (C_{dl}). Aᵣₑₐₗ capacitance of the smooth hematite surface (i.e., 0.55 microfarad per square centimeter (μF/cm²), the Aᵣₑₐₗ and roughness factor (RF) of hematite photoanodes can be evaluated using equations (5, 6), respectively:

$${A}_{real} = \frac{{c}_{dl}}{0.55} \qquad ( 5 )$$

$$RF = \frac{{A}_{real}}{{A}_{geomemcal}} \qquad ( 6 )$$

The geometrical area (A_{geometrical}) is 0.25 cm². The Aᵣₑₐₗ of the BH, Pi-H, and CoFe-PBA/Pi-H electrodes were found to be 2.1, 2.3, and 2.4 cm², respectively. The RFs values for the BH, Pi-H, and CoFe-PBA/Pi-H electrodes were found to be 8.4, 9.3, and 9.4, respectively.

### Example 6: Density Functional Theory (DFT) Simulations

DFT simulations have been conducted employing Vienna ab initio simulation package (VASP) as described in the published art. Slab with (001) facet was constructed with a supercell of 120-atoms 2×2×1 and 15 angstroms (Å) as a vacuum layer to avoid spurious interactions between the slab and corresponding image. The resulted dimensions of the slab were 10.22×10.16 in XY directions with twelve layers of thickness, six layers were fixed, and six layers were allowed to relax during the geometric optimization. Mono-protonated and mononuclear (on one iron site) structure has been used as initial geometries for anchored phosphate/hematite complex and the mono-protonated and mononuclear structure is posed on an oxygen vacancy site.

### Example 7: Characterization

Formation of hematite hexagonal crystal structure has been proved by analyzing X-ray diffraction (XRD) patterns of the BH, Pi-H, and CoFe-PBA/Pi-H films (FIG. 4). Vertical lines indicate Bragg positions for the hematite crystal structure (JCPDS card no. 033-0664). For example, characteristic diffraction peaks of (110) and (300) hematite surfaces, located at 20 of 35.4° and 64.0°, respectively (Joint Committee on Powder Diffraction Standards (JCPDS) card no. 033-0664), are observed. The relatively high intensity of the diffraction peak located at 35.4° in comparison with that at 64.0° indicates the preferential growth along the (110) direction. The growth of the hematite crystal along the (110) direction is beneficial for facile electron transfer due to the high mobility of electrons in the particular direction. The rest of the diffraction peaks are attributed to FTO glass substrate (JCPDS card no. 041-1445). No significant changes have been observed in the diffraction pattern of the BH upon the modification with Pi and/or CoFe-PBA evincing that the Pi and CoFe-PBA layers are very thin and beyond the detection limit of the XRD technique or the Pi and CoFe-PBA layers have an amorphous nature.

Intensity of the hematite peaks is very low because the hematite films are very thin, and the samples have been analyzed in Bragg-Brentano configuration. Thus, the Raman analysis was further examined to confirm the formation of the hematite crystalline structure. As shown in FIG. 5, the prominent Raman peaks of the hematite structure were assigned to E_{g} (243, 290, 410, and 610 cm⁻¹) and A_{1g} (224 and 502 cm⁻¹) photon modes which can be readily observed for the BH, Pi-H, and CoFe-PBA/Pi-H films. Star symbol (*) in FIG. 5 represents the peaks attributed to the FTO coated glass substrate.

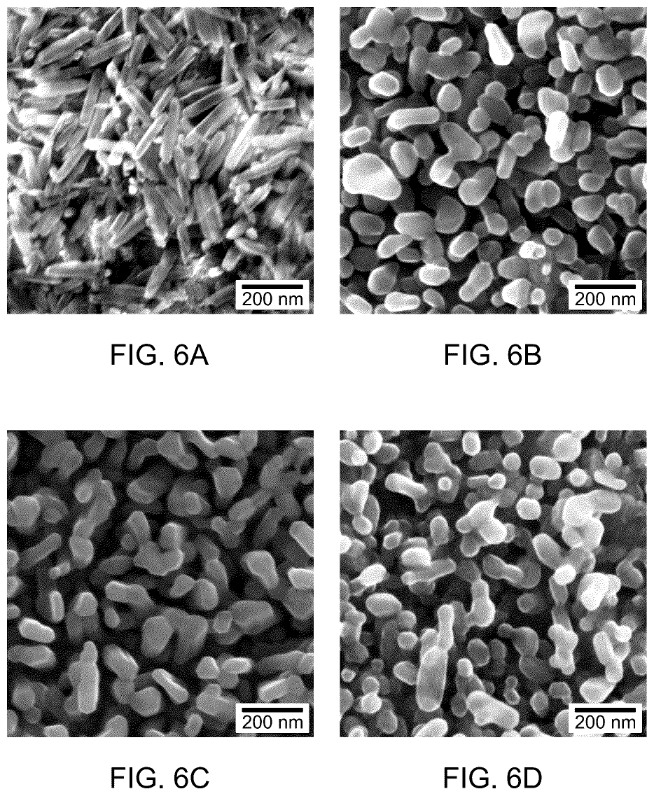

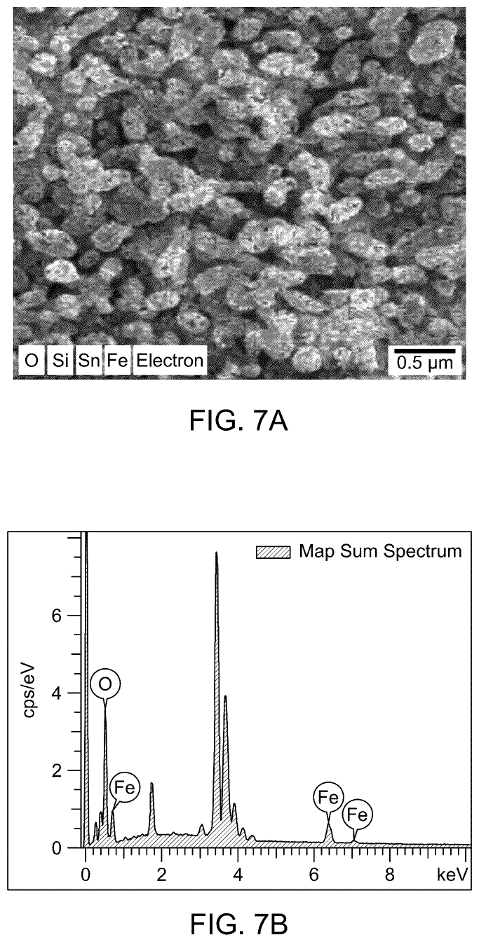

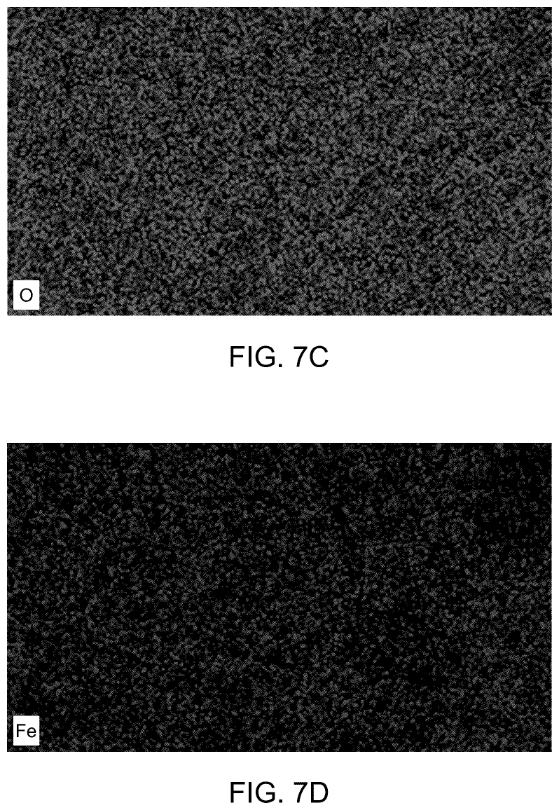

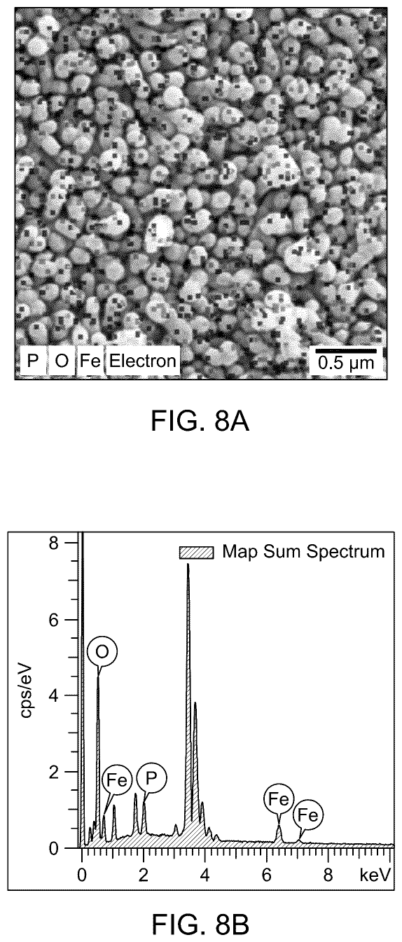

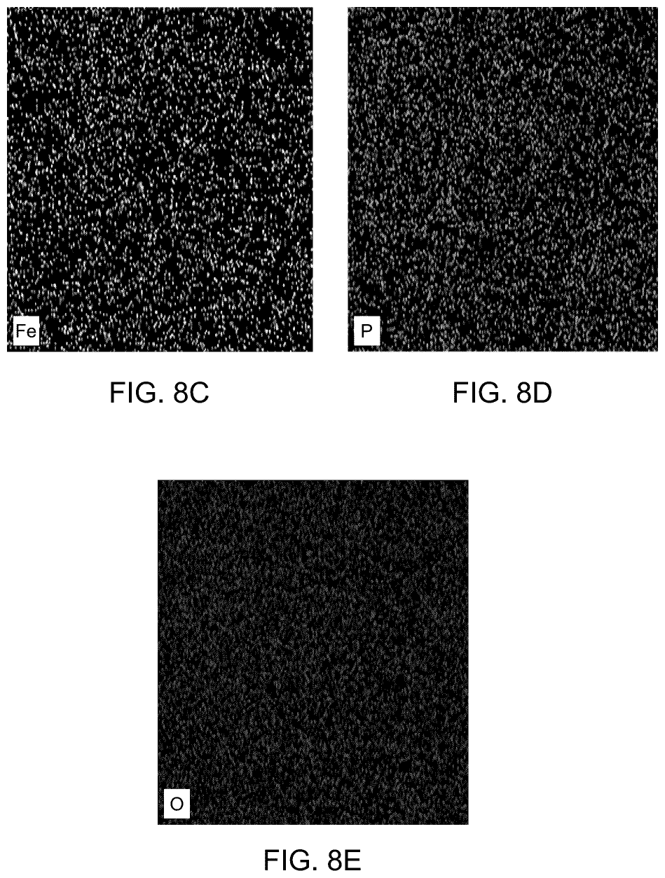

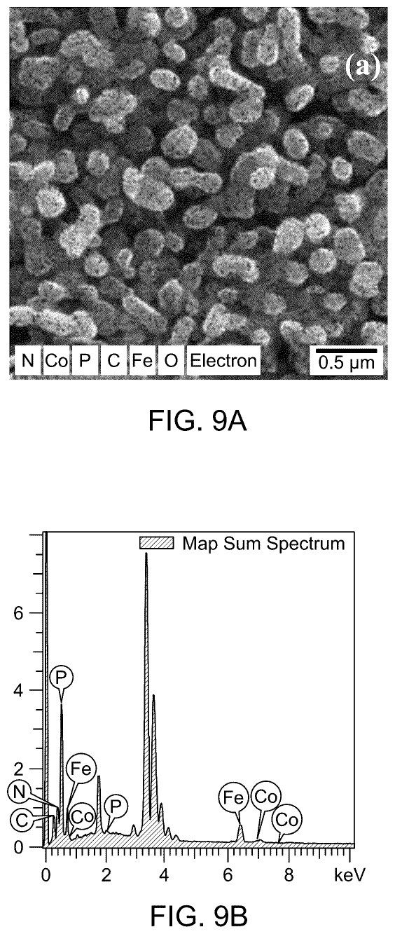

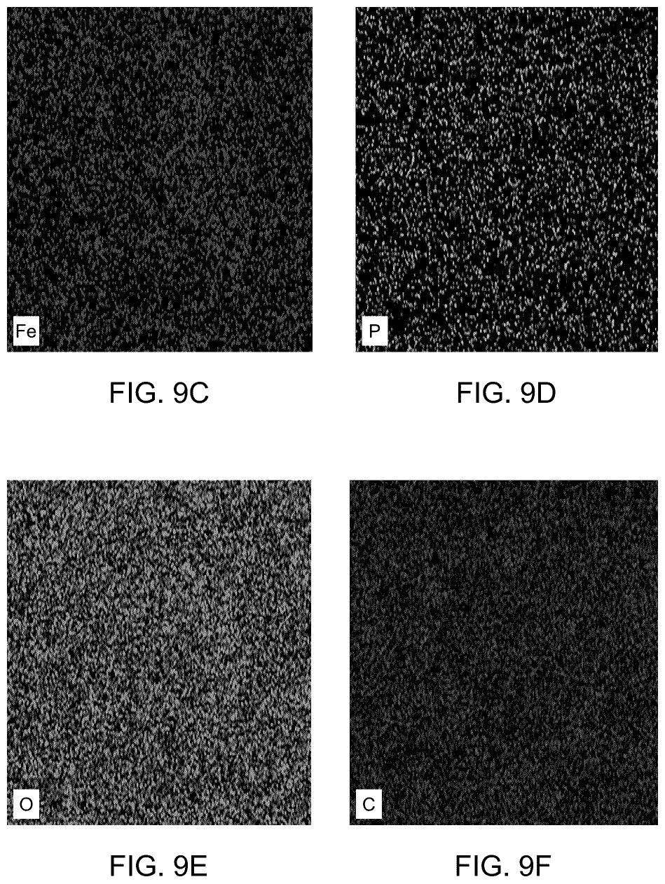

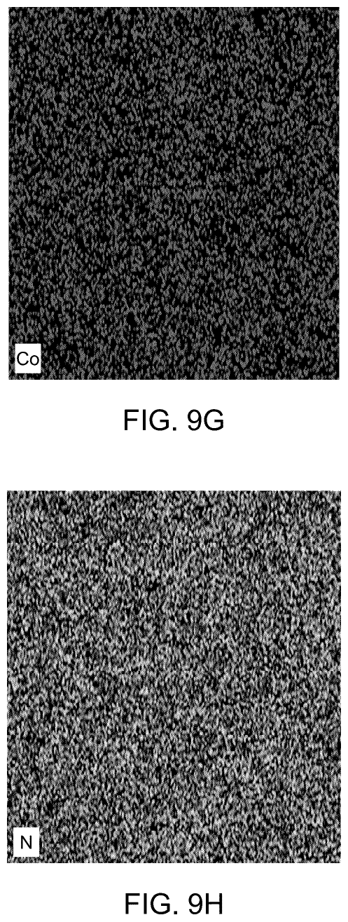

Morphologies of the β-FeOOH, BH, Pi-H, and CoFe-PBA/Pi-H films have been investigated by scanning electron microscope (SEM) and are presented in FIGS. 6A-6D, respectively. Analysis of the SEM micrographs indicated that the β-FeOOH film includes a compact layer of nanorods with a diameter of approximately 50 nm (FIG. 6A). After calcination, rod-like particles have been formed and diameters of the rod-like particles increased up to 100 nm (FIG. 6B). After the modification of the BH films with either Pi and/or CoFe-PBA, morphologies of the modified BH films remain the same evincing that the deposited Pi and/or CoFe-PBA layers are very thin and beyond the resolution of the SEM techniques. However, energy-dispersive X-ray spectroscopy (EDXS) spectra shown in FIGS. 7A-9H confirmed the existence of P, Co, C, and N in the modified hematite films. High-intensity peaks of Sn and Si originate from the conductive F-doped SnO₂ layer coated on the FTO substrate.

To prove the existence of Pi and CoFe-PBA on the hematite's surface, XPS spectra of the BH, Pi-H, and CoFe-PBA/Pi-H films have been measured and analyzed. FIG. 10 illustrates the low-resolution XPS survey spectra, which confirm the existence of P 2p in the Pi-H film and P 2p and N 1s core-levels in the CoFe-PBA/Pi-H film. None of them can be observed in the BH film, which indicates the successful modification of the BH with Pi and CoFe-PBA/Pi layers. FIG. 11A presents high-resolution X-ray photoelectron spectroscopy (HR-XPS) spectra of the P 2p core-level. Characteristic XPS peak of P 2p located at 133.7 eV can be only found in the Pi-H and CoFe-PBA/Pi-H films confirming that the phosphate group is well anchored to the hematite surface. For the BH film, two XPS peaks located at ˜710.6 and ˜724.0 eV and separated by approx. 13.4 eV (i.e., spin-orbit splitting energy, ΔE) can be assigned to Fe 2p_{3/2} and 2p_{1/2}, respectively. The two peaks confirm the presence of iron in the oxidation state of +3 (FIG. 11B).

A little shift towards lower binding energy observed after the modification with CoFe-PBA indicates the coexistence of iron +2 in the CoFe-PBA layer. HR-XPS spectrum of Co 2p core levels in the CoFe-PBA/Pi-H film is shown in FIG. 11C. A broad XPS spectrum was observed more likely due to the overlap of the XPS spectra of the mixed oxidation state of Co (i.e., oxidation states +2 and +3) in the CoFe-PBA layer. To make reasonable deconvolution of the overlapped peaks was not possible due to the low intensity of the signal. To confirm further the coexistence of the mixed oxidation states of cobalt, the CoFe-PBA power was prepared and isolated under the same conditions as for the modification of hematite film, and the XPS spectrum was measured and presented in FIG. 11D. Analysis of the XPS spectrum of the isolated CoFe-PBA powder confirms the coexistence of Co in the oxidation state +2 and +3. Presence of CoOₓ has been excluded due to the absence of the CoOₓ characteristic peaks at 780 eV. This confirms that Co ions are mainly bound with cyanide ions in the matrix or partly to the oxygen of water and not with oxygen to form CoOₓ. Presence of N 1s XPS peak at 399.3 eV as shown in FIG. 11E can be assigned to the nitrogen in cyanide ions. HR-XPS spectra of O1s core levels in BH and Pi-H films are shown in FIG. 11F. The spectra can be de-convoluted into three peaks corresponding to the various oxygen species (FIG. 11G for the Pi-H film and FIG. 11H for the BH film). In FIG. 11G, peak located at ˜529.8 eV belongs to the lattice oxygen bond (O²⁻), while peaks located at ˜531.5 and ˜532.3 eV are oxygen vacancies and surface adsorbed oxygen species, respectively. The oxygen vacancies (defected oxygen sites), that might be resulted from the defects in the surface bounded phosphate ion layer, modify the coordination of O atoms and the chemical valence of Fe atoms, and thus the oxygen vacancies change the O—Fe bonds and alter the XPS spectrum of O 1s as published in the art. Areas under the three de-convoluted peaks was analyzed and tabulated (Table 1).

TABLE 1
Areas of deconvoluted peaks (%) of BH, P-H, and CoFe-PBA/P-H
films obtained from the fitting of O1s XPS spectra.

| | Lattice | Oxygen | Surface |
|---|---|---|---|
| | Oxygen | vacancies | Adsorbed |
| Film | (%) | (%) | Oxygen Species |
| BH | 74.8 | 21.9 | 3.3 |
| P-H | 47.7 | 45 | 7.3 |
| CoFe-PBA/P-H | 57.4 | 32.7 | 9.9 |

Table 1 depicts that the surface of hematite is enriched with oxygen vacancies (defect sites) after the modification of the hematite with the Pi layer. The modification of the hematite with phosphate ions induces the formation of defect sites. Moreover, the binding energy of the O 1s in Pi-H was slightly lower than that in the BH, implying that the anchored phosphate ions change the surface electronic properties of bare hematite. On realistic surfaces of hematite, various kinds of surface defects exist and play various roles. Some defects have a positive impact on the PEC water oxidation (i.e., facilitating the water oxidation process), but the rest lead to severe interfacial recombination at the semiconductor/electrolyte (S-E) interface.

### Example 8: Modification and PEC Measurements

The detailed PEC performance of bare and modified hematite photoanodes was assessed in an aqueous solution of 1.0 M NaOH under STC (i.e., 1.0 sun, AM 1.5 G). Linear sweep voltammetry (LSV) and chronoamperometry (CA) procedures were used to measure the continuous and chopped photocurrent. Based on the pH value, the surface hydroxyl groups of hematite, as a metal oxide, can be either protonated (positively charged) or deprotonated (negatively charged) when dipped in an aqueous solution. At a pH value equal to the point of zero charge (pH_{PZC}), the surface of hematite will remain un-charged. For instance, a surface of hematite may remain un-charged in the pH range from 7 to 9.5 (i.e., at pH values equal to the point of zero charge). Thus, at pH less than the pH_{PZC}, the surface of hematite may maintain a positive charge, and hence the electrostatic adsorption of PO₄³⁻ ions (Pi) is favorable.

Attenuated Total Reflectance-Fourier Transform Infrared Spectroscopy (ATR-FTIR) spectroscopy was used in the past to examine the adsorption of phosphate ions on the surface of hematite at a wide range of pH values. Several observations were noted from the experiment. For example, the pH value affected the adsorption process and various phosphate complexes could exist on the surface of hematite, but the formation of the mono-protonated phosphate species bound in a monodentate bridging fashion was favoured in the pH range from 3.5 to 7.0. To define the optimum pH value for anchoring the Pi onto the surface of hematite via adsorption, the BH films were immersed for various time intervals (i.e., 30-120 minutes) at various pH values (i.e., pH 4.0-7.0) in phosphate aqueous solutions. After the adsorption step, the BH films were washed with de-ionized water to remove the unattached phosphate ions, subsequently, the modified hematite films were calcined at various temperatures from (300 to 400° C.) for various time intervals (i.e., 30-150 minutes) to improve the adhesion of the Pi layer.

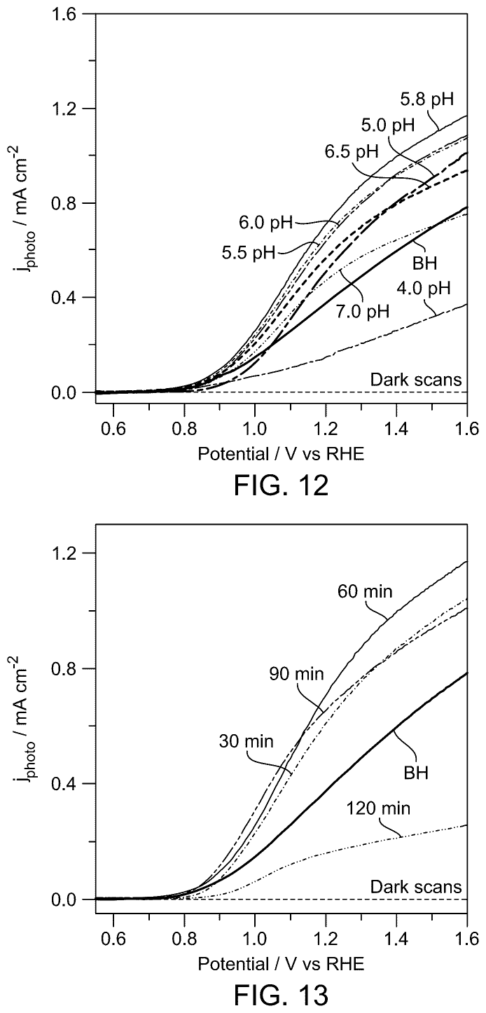

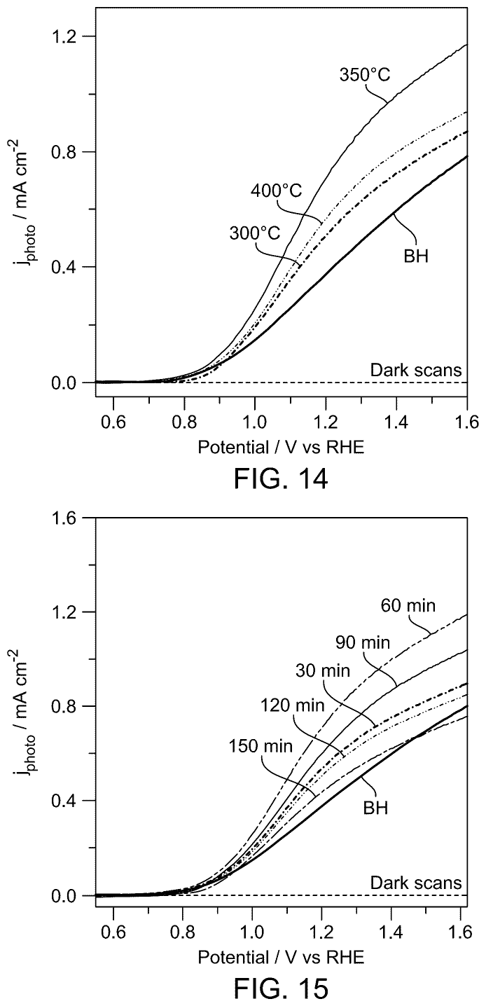

FIGS. 12-15 illustrate photocurrent responses of the fabricated Pi-H photoanodes at various modification conditions. For example, FIG. 12 includes the modifications conditions such as the hematite films were immersed for 60 min in 0.5 mol/L phosphate buffer aqueous solutions at various pH (i.e., 4-7), followed by calcination at 350° C. for 60 minutes with scan rate 5° C./minute. FIG. 13 includes the modifications conditions such as the hematite films were immersed in the 0.5 mol/L phosphate buffer aqueous solutions for various times (i.e., 30-120 minutes) at pH 5.8, followed by calcination at 350° C. for 60 minutes with the scan rate 5° C./minute. FIG. 14 includes the modification conditions such as the hematite films were immersed in the 0.5 mol/L phosphate buffer aqueous solutions for 60 minutes at pH 5.8, followed by calcination at various temperatures (i.e., 300-400° C.) for 60 minutes with the scan rate 5° C./minute. FIG. 15 includes the modification conditions such as the hematite films were immersed in the 0.5 mol/L phosphate buffer aqueous solutions for 60 minutes at pH 5.8, followed by calcination for various times (i.e., 30-150 minutes) at temperature 350° C. with the scan rate 5° C./minute.

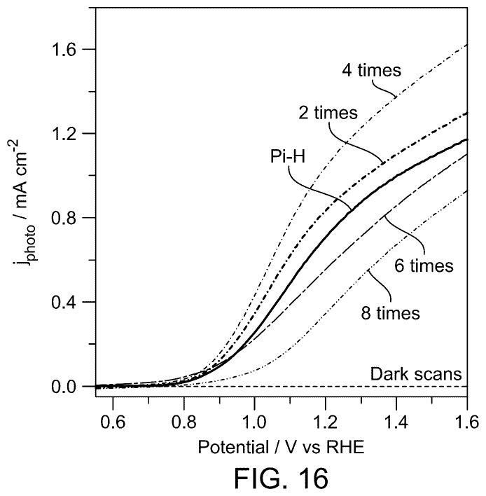

From FIGS. 12-15 it can be observed that the Pi-H photoanode fabricated by dipping in 0.5 M phosphate buffer for 60 min at pH 5.8 and subsequently annealed at 350° C. for 1.0 h exhibits the highest PEC activity. The modification of Pi-H photoanode with CoFe-PBA OEC was further investigated using a sequential dipping method. The Pi-H electrode was dipped in 0.02 M K₃[Fe(CN)₆] aqueous solutions for 15 min followed by immersing in 0.04 M CoCl₂ aqueous solution for 15 min. Repeating the process for 4 cycles produces the highest PEC activity (as shown in FIG. 16). FIG. 16 includes modification conditions such as the Pi-H electrode was first immersed in 0.02 mol/L K₃[Fe(CN)₆] aqueous solutions for 15 minutes and subsequently immersed in 0.04 mol/L CoCl₂ aqueous solutions for 15 minutes for multiple times dipping. The Pi-H electrode was clean with de-ionized water and was dried after each successive immersion in the aqueous solutions.

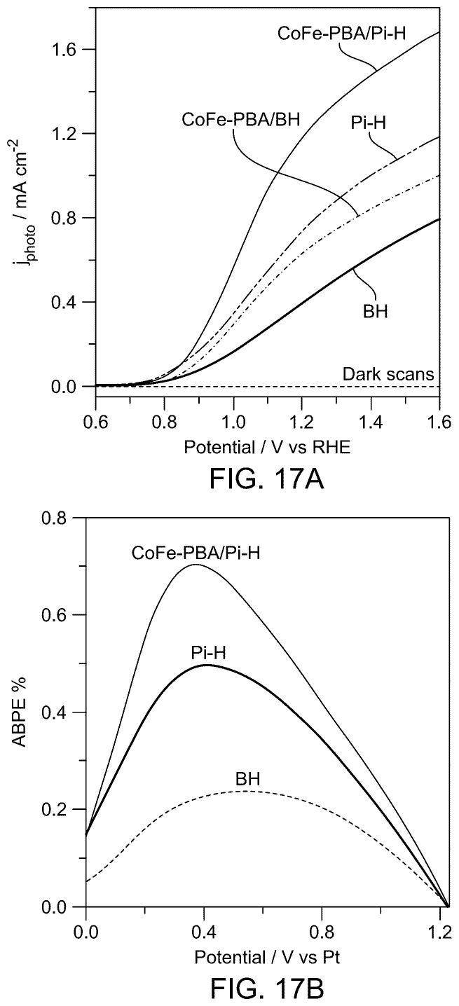

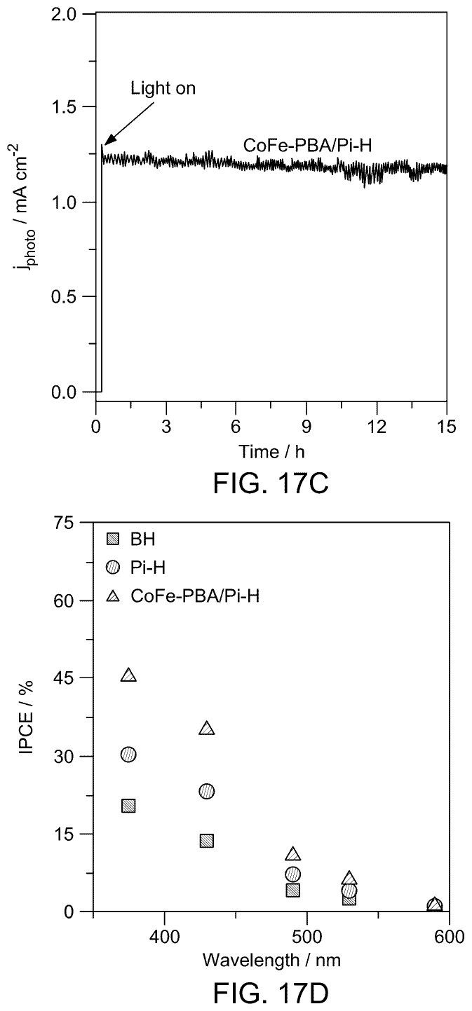

The Pi-H photoanode exhibits 0.78 mA/cm² at 1.23 V_{RHE} under STC, which is 1.8-fold greater than that of BH photoanode (0.43 mA/cm²) and consistent with the previously reported values. Co-modification of the BH with Pi layer and CoFe-PBA OEC enhance the photocurrent by 2.9-fold to reach 1.24 mA/cm² at 1.23 V_{RHE} as shown in FIG. 17A. The present value is 6-fold higher than the value reported for the hematite photoanode modified with only CoFe-PBA OEC (i.e., 0.2 mA/cm²). A simple modification of the BH photoanode with only Pi or CoFe-PBA OEC layer may not allow to reach the mentioned value of the photocurrent. The simple modification of the BH photoanode with only Pi or CoFe-PBA OEC layer evincing that the Pi interfacial layer between the hematite surface and CoFe-PBA OEC plays a crucial role. The Pi layer between CoFe-PBA and BH provides a new path to drift and store the photogenerated holes making the photogenerated holes energetically accessible for water oxidation via the CoFe-PBA OEC.

FIG. 17B depicts photo-conversion efficiency as a function of applied potentials for the BH, Pi-H, and CoFe-PBA/Pi-H photoanodes. Maximum ABPE of CoFe-PBA/Pi-H photoanodes reaches 0.70% at 0.37 V_{Pt}, which is 1.5 and 3-time higher than that of Pi-H (i.e., 0.50% at 0.41 V_{Pt}) and BH (i.e., 0.24% at 0.57 V_{Pt}), respectively. Moreover, the potential at the maximum ABPE for the CoFe-PBA/Pi-H photoanode is shifted cathodically by 200 mV in comparison with that of BH which can be attributed to the reduced surface recombination at semiconductor/electrolyte interface (SEI) and the enhanced photovoltage. The PEC stability of CoFe-PBA/Pi-H photoanode was investigated by applying a constant bias potential (i.e., 1.23 V_{RHE} at pH=13.6) for 15 h (FIG. 17C). The fluctuations of the obtained photocurrent were as low as 4%, proving that the CoFe-PBA/Pi-H photoanode exhibits high stability. The photocurrent improvement was further verified by measuring the IPCE as a function of the incident photons wavelength. The IPCE of the BH, Pi-H, and CoFe-PBA/Pi-H photoanodes measured at 1.23 V_{RHE} are demonstrated in FIG. 17D.

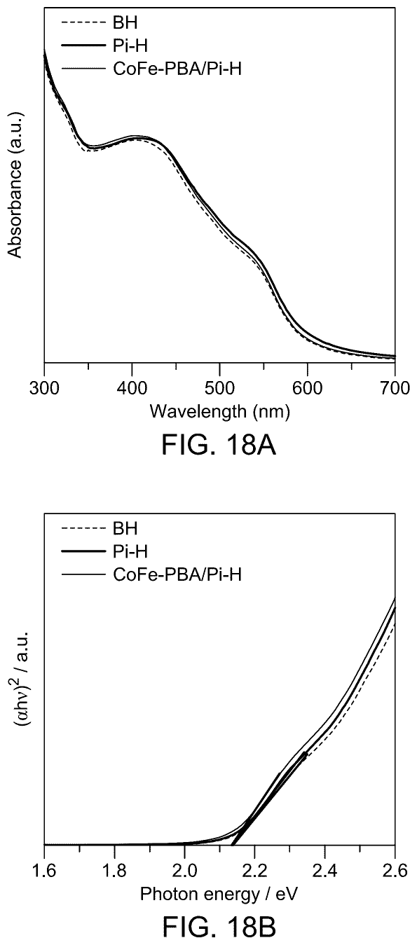

In agreement with the LSV curves presented in FIG. 17A, the CoFe-PBA/Pi-H exhibits the highest IPCE (i.e., 35.1% at 430 nm). To confirm that the photocurrent improvement is due to the surface modification of hematite photoanode with Pi layer and CoFe-PBA OEC and not due to the difference in the light absorption capability, the optical properties of the BH, Pi-H, and CoFe-PBA/Pi-H photoanodes have been measured. The bare and modified hematite photoanodes showed almost the same light absorption properties and bandgap (FIGS. 18A-18B). This implies that the PEC improvement is mainly due to the surface modification with Pi layer and CoFe-PBA OEC.

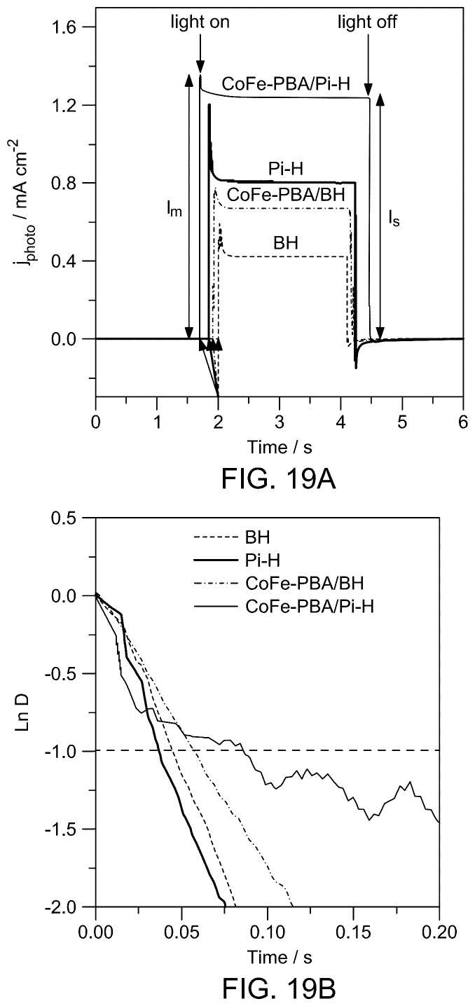

Influence of the Pi layer and CoFe-PBA OEC on transient decay time (τ) of the photogenerated holes has been examined. Anodic and cathodic spikes are observed in transient photocurrent (TPC) responses as shown in FIG. 19. When the light is turned on, an anodic photocurrent spike (Iₘ) is generally observed due to the movement of the photogenerated holes towards the SEI where the photogenerated holes are accumulated at surface trapping states due to the slow kinetics of water oxidation. During continuous illumination, steady-state current (Iₛ) is established, where the arrival of holes concentration is balanced by holes recombination and transfer for OER. Area under an anodic spike peak is proportional to the amount of surface trapped holes. Such areas were calculated by integration and found to be 8.43±0.78, 11.26±0.35, 7.51±0.14, and 5.22±0.21 microcoulomb per square centimeter (μC/cm²) for the BH, Pi-H, CoFe-PBA/BH, and CoFe-PBA/Pi-H photoanodes, respectively.

The amount of the accumulated holes in the Pi-H is significantly higher than that of the BH indicating that the Pi layer acts as a hole accumulation layer. Moreover, photocurrent spike of the Pi-H is much higher than that of the BH indicating that the Pi layer facilitates the drift of the photogenerated holes toward the SEI. The concentration of accumulated holes and the photocurrent spike are then reduced upon the modification with CoFe-PBA OEC. The reduction can be attributed to the passivation of surface states by CoFe-PBA and the transfer of the photogenerated holes to the CoFe-PBA OEC where the photogenerated holes partake in the water oxidation process. When the light is off, conduction band electrons recombine with the surface trapped holes to give a cathodic current spike.

The cathodic current spike of the Pi-H is more significant than that of the BH, CoFe-PBA/BH, and CoFe-PBA/Pi-H photoanodes indicating again that the Pi-H exhibits a higher amount of surface trapped holes evincing that the Pi layer is accumulating the holes at the surface of the hematite photoanode. The transient decay time (τ) was further calculated. r is defined as the time at which ln(D)=−1 and the D parameter is determined by using equation (7).

$$D = \frac{( {I}_{t} - {I}_{s} )}{( {I}_{m} - {I}_{s} )} \qquad ( 7 )$$

Where Iₜ is the time-dependent current, Iₘ is the photocurrent spike, and Is the steady-state current as illustrated in FIG. 19A.

Normalized D value plotted versus time is presented in FIG. 19B. The τ values of the BH, Pi-H, CoFe-PBA/Pi-H, and CoFe-PBA/Pi-H photoanodes were estimated to be 45, 37, 58, and 86 ms, respectively. Generally, a slower recombination rate leads to a higher τ value. The significantly high transient decay time (τ) of the CoFe-PBA/Pi-H relative to the Pi-H and CoFe-PBA/BH indicates that synergy between the Pi layer and CoFe-PBA OEC has a positive impact on charge separation efficiency. Transfer of the accumulated holes at the Pi layer to the CoFe-PBA OEC makes the hole available for a longer time at the surface, and thus, the holes can be readily involved in the water oxidation process. In absence of the CoFe-PBA, the Pi-H photoanode exhibits the highest amount of surface trapped holes, however, corresponding shorter lifetime limits the PEC efficiency. Defects induced by the Pi layer on the hematite surface drift the photogenerated holes toward the surface, but corresponding surface recombination with the conduction band electrons dominates the process and limits the water oxidation process.

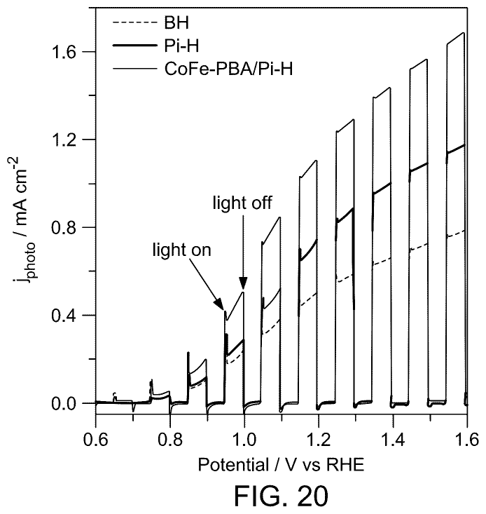

FIG. 20 shows LSV of the BH, Pi-H, and CoFe-PBA/Pi-H photoanodes measured under chopped light. Several observations were noted from FIG. 20. For example, with increasing the applied potential, the anodic spikes are diminished indicating that the applied positive bias suppresses electron concentration at the surface and evacuates the surface states. At relatively low bias potential, comparison of the anodic and cathodic spikes revealed that the anodic and cathodic peaks are less for the CoFe-PBA/Pi-H than the Pi-H and BH. The CoFe-PBA suppresses the surface recombination by passivating the surface defects and accelerates the holes injection into the solution for the water oxidation process.

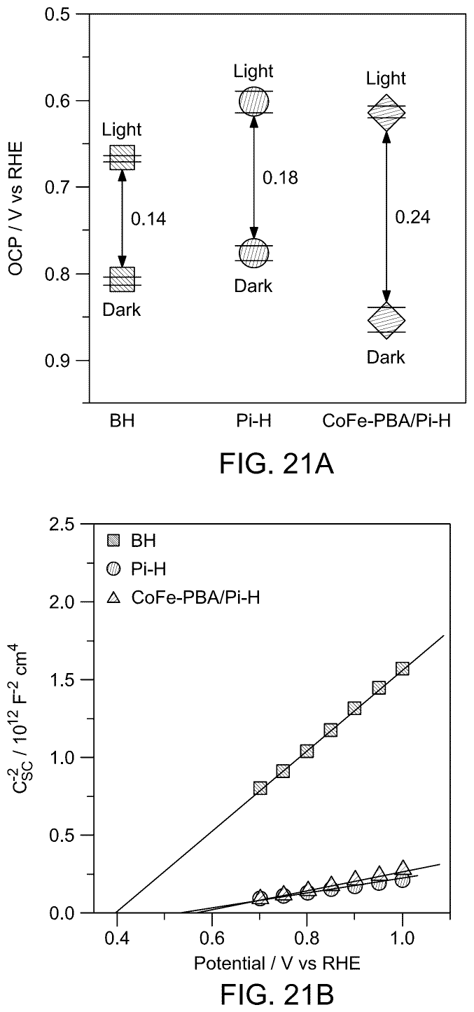

The enhanced PEC performance of the CoFe-PBA/Pi-H photoanode was further verified by measuring generated photovoltage (Vₚₕ). The Vₚₕ was calculated from the difference of light and dark open-circuit potentials (OCP_{light}-OCP_{dark}). FIG. 21A illustrates cathodic shift of the OCP under illumination which is a characteristic property of n-type material. The results indicated that the Vₚₕ of CoFe-PBA/Pi-H (i.e., 0.24 V) is higher than of Pi-H (i.e., 0.18 V) and BH (i.e., 0.14 V) photoanodes, which indicates that the CoFe-PBA passivate the surface defects and reduces the surface recombination. The surface modification of BH with Pi interfacial layer and/or CoFe-PBA OEC might affect electrochemical surface area (ECSA) and hence the PEC activity. To investigate the mentioned assumption, the ECSA has been measured (FIGS. 3A-3D). Several observations were noted. For example, the BH, Pi-H, and CoFe-PBA/Pi-H photoanodes exhibit approximately the same ECSA and thus the ECSA has an insignificant influence on the PEC activities of the investigated photoanodes.

### Example 9: EIS and IMPS Measurements

Effect of the Pi layer on flat band potential (E_{fb}) and donor density (N_{d}) of the fabricated hematite electrodes have been investigated by EIS. FIG. 21B shows Mott-Schottky (M-S) plots of the BH, Pi-H, and CoFe-PBA/Pi-H electrodes constructed at 1.0 kHz using equation (8).

$$\frac{1}{{C}_{SC}^{2}} = \frac{2}{q ε {ε}_{0} {A}^{2} {N}_{d}} ( E - {E}_{fb} - \frac{kT}{q} ) \qquad ( 8 )$$

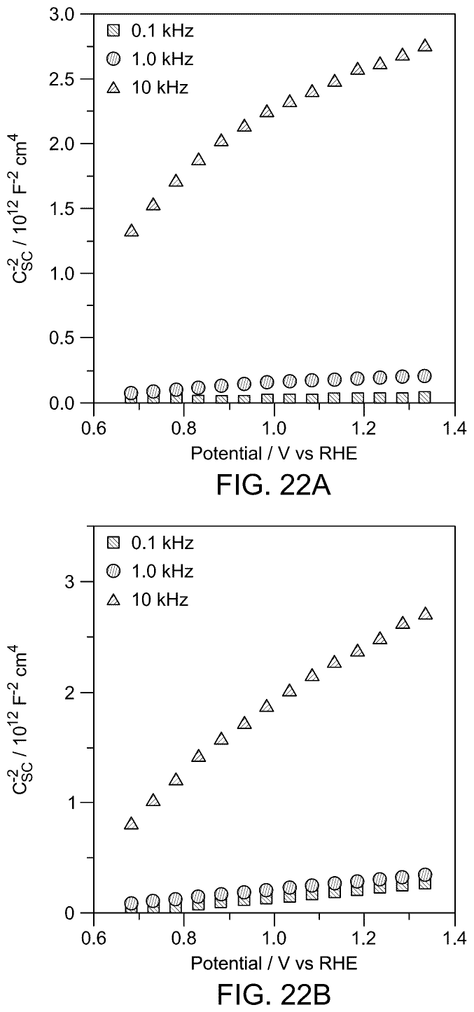

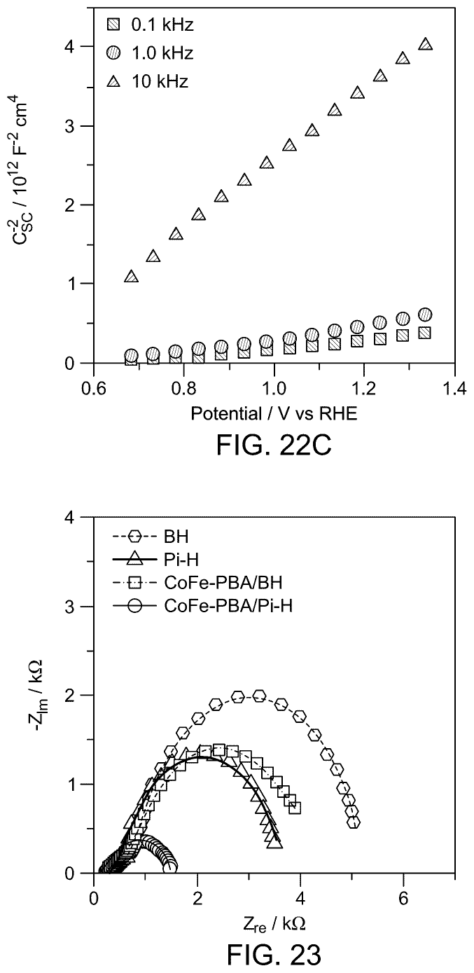

Electrodes exhibit a straight line with a positive slope, which divulged that the electrodes are n-type materials with electrons are the majority charge carriers. FIGS. 22A-22C displays M-S plot of the BH, Pi-H, and CoFe-PBA/Pi-H measured at 0.1 and 10 kHz which show the same trend as that measured at 1.0 kHz but having a various slope. The difference in the slope is commonly encountered and generally attributed to the dispersion of the measured capacitances because of the roughness of the electrode surface. The M-S plot recorded at 1.0 kHz has been used to calculate the donor density for ease of comparison with the literature. The donor densities have been derived from the slopes acquired from the linear regression fitting according to the M-S equation.

Several observations were noted. For example, the donor density of the Pi-H is increased by approximately 5-fold, i.e., from 1.54×10¹⁷ cm⁻³ for the BH to 8.12×10¹⁷ cm⁻³, which indicates that the phosphate ions create defects on the surface of hematite and induce more oxygen vacancies. The present finding is consistent with the XPS and TPC results. Flat band potential has been determined from the intercept of the M-S plot with the X-axis at C_{SC}⁻² equal to zero and was found to be approximately 0.37 V_{RHE} for the BH. The E_{fb} of the Pi-H and CoFe-PBA/Pi-H electrodes were found to be 0.52 and 0.55 V_{RHE}, respectively (shown in table 2).

TABLE 2
Donor density (N_{d}) of the BH, Pi-H, and CoFe-PBA/Pi-H electrodes
calculated at 1.0 kHz frequency using real and geometrical areas. Flat
band (E_{fb}) potentials of the electrodes are also shown.

| | N_{d} (cm⁻³)^{a} | N_{d} (cm⁻³)^{b} |
|---|---|---|
| Electrode | (E_{fb} (V)) | (E_{fb} (V)) |
| BH | 1.11 × 10¹⁹ | 1.57 × 10¹⁷ |
| | −0.37 | −0.37 |
| Pi-H | 7.07 × 10¹⁹ | 8.35 × 10¹⁷ |
| | −0.52 | −0.52 |
| CoFe-PBA/Pi-H | 4.32 × 10¹⁹ | 4.69 × 10¹⁷ |
| | −0.55 | −0.55 |

^{a}Geometrical area,
^{b}Real surface area

The OCP_{light} can be used to verify the E_{fb} provided that the material does not have very fast surface recombination. The determined E_{fb} for the Pi-H and CoFe-PBA/Pi-H electrodes are consistent with the measured OCP_{light} (i.e., 0.60 V_{RHE} for the Pi-H and 0.61 V_{RHE} for the CoFe-PBA/Pi-H) evincing the reliability of the results. For the BH electrode, the OCP_{light} (i.e., 0.67 V_{RHE}) is more anodic than the true E_{fb} due to the high rate of carrier's recombination, as expected for n-type semiconductors. Despite the anodic shift of the flat band potential of the CoFe-PBA/Pi-H photoanode relative to that of BH, the CoFe-PBA/Pi-H photoanode exhibits higher PEC activity at a lower bias potential.

Co t_{2g} hole-acceptor states of the CoFe-PBA are located slightly at lower energy than valence band (VB) edge of the hematite. Thus, there is no driving force for the hole to be transferred from the VB of the hematite to the CoFe-PBA OEC. Since the bandgaps of the BH, Pi-H, and CoFe-PBA/Pi-H electrodes are the same (FIG. 18B), the anodic shift of the flat band potential observed after the modification with the Pi layer results in a shift of the valance band edge in the same direction. Therefore, the VB edge of the hematite may be shifted to a lower energy level than that of the Co t₂g hole-acceptor states and thus the hole transfer from the VB of hematite to the CoFe-PBA may be energetically more favorable.

However, the provided information along with the enhanced Vₚh indicates that the synergy between the Pi interfacial layer and the CoFe-PBA OEC suppresses the surface recombination and facilitates the charge transfer, no significant cathodic shift in the onset potential. No significant cathodic shift may be attributed to the energy level of the Co t₂g hole-acceptor states in CoFe-PBA are fairly close to the VB edge of BH and the entire band structure of hematite is shifted anodically after modification. Since the electric field within the space charge layer is the main driving force for the separation of the electron/hole pairs, only the generated charge carriers within the range of (Lₚ+W) can reach the SEI (where Lₚ is the hole diffusion length and W is the depletion layer width). The short hole diffusion length of hematite (2-3 nm) may lead to high probability for recombination within the space charge layer. Thus, reducing the width of the space charge layer may reduce the surface recombination and enhance the PEC activity assuming that a significant portion of the light is absorbed within the space charge layer. The W of the BH, Pi-H, and CoFe-PBA/Pi-H photoanodes has thus been calculated using equation (9).

$$W = \sqrt{\frac{2 ( ε {ε}_{0} ( {E}_{app} - {E}_{FB} )}{{qN}_{d}}} \qquad ( 9 )$$

where Eₐₚₚ and E_{FB} denote the applied and flat band potentials, respectively.

The depletion layer widths of the BH, Pi-H, and CoFe-PBA/Pi-H at 1.23 V_{RHE} are 26.4, 8.9, and 11.8 nm, respectively. The decreased depletion layer width for the Pi-H and CoFe-PBA/Pi-H relative to that of the BH may shorten charge collection distance. Thus, more holes can be drifted toward the SEI and have a higher probability to participate in the water oxidation process at the CoFe-PBA OEC. Nyquist spectra measured at 0.9 V_{RHE} and presented in FIG. 23 confirmed that the CoFe-PBA OEC facilitates the water oxidation process in a more efficient way in presence of the Pi layer.

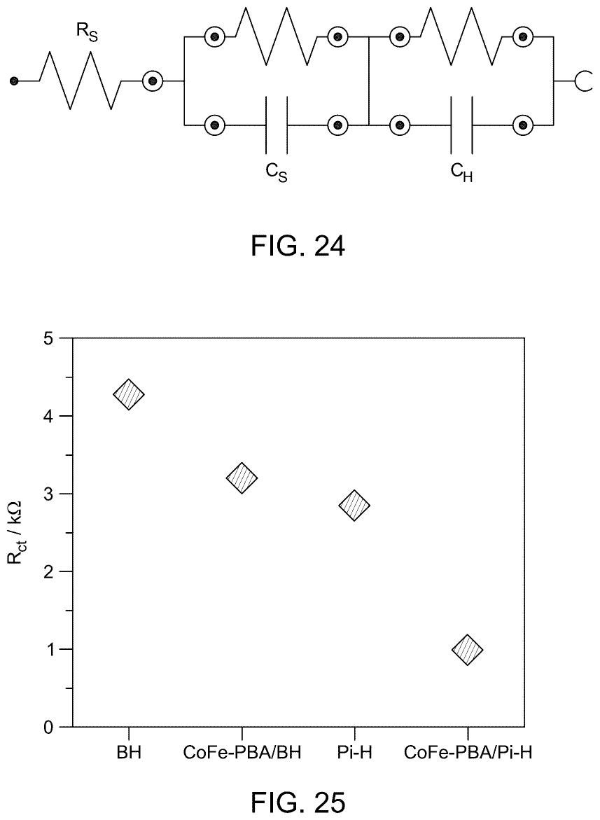

As shown in FIG. 23, the size of low frequency (LF) semicircle, which corresponds to impedance events at the SEI, particularly charge transfer resistance R_{ct}, is significantly decreased after the modification of the Pi-H photoanode with the CoFe-PBA OEC. By fitting Nyquist spectra to an equivalent circuit presented in FIG. 24. In FIG. 24 two resistor-capacitor circuits (RC) can be assigned to an electrode/electrolyte interface (RCT/CH) and an electron transport inside an electrode (R_{bulk}/CSC). The R_{ct} has been calculated and presented in FIG. 25. However, modification of the BH with the Pi layer or CoFe-PBA OEC reduces to some extent the R_{ct} value, such modification was not able to reach the R_{ct} value of the CoFe-PBA/Pi-H photoanode. Such results indicate that the Pi interfacial layer is essential to extract the photogenerated holes from light-harvesting hematite photoanode and transfer the photogenerated holes to the CoFe-PBA OEC. The present step is essential to reduce the surface recombination and accelerate the kinetics (holes transfer) for the water oxidation process.

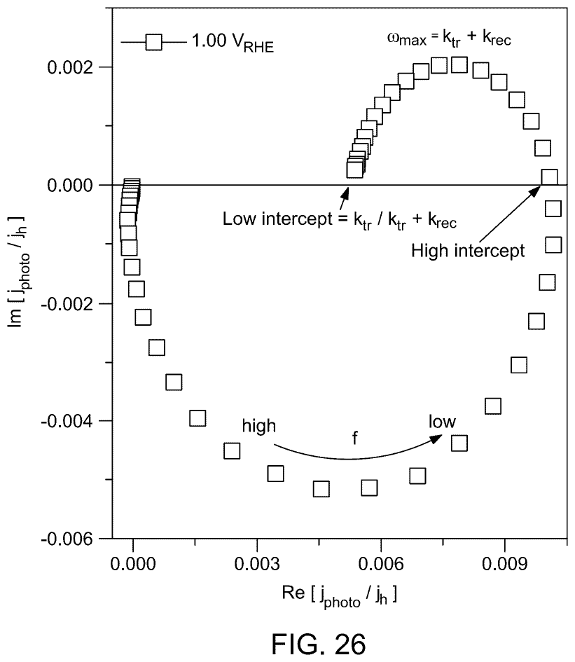

The synergy between the Pi layer and CoFe-PBA OEC and corresponding influence on the charge transfer efficiency has further been examined by the IMPS technique. FIG. 26 illustrates IMPS response for the BH photoanode measured at 1.0 V_{RHE}. FIG. 26 includes high frequency (HF) and low frequency (LF) semicircles located at first and fourth quadrants. The HF semicircle starts from the fourth quadrant and represents the RC time constant of the cell, which includes the total resistance of the cell and combined capacitance of the space charge layer and Helmholtz layer capacitance. The LF semicircle appears in the first quadrant, where the charge transfer process and surface recombination dominate.

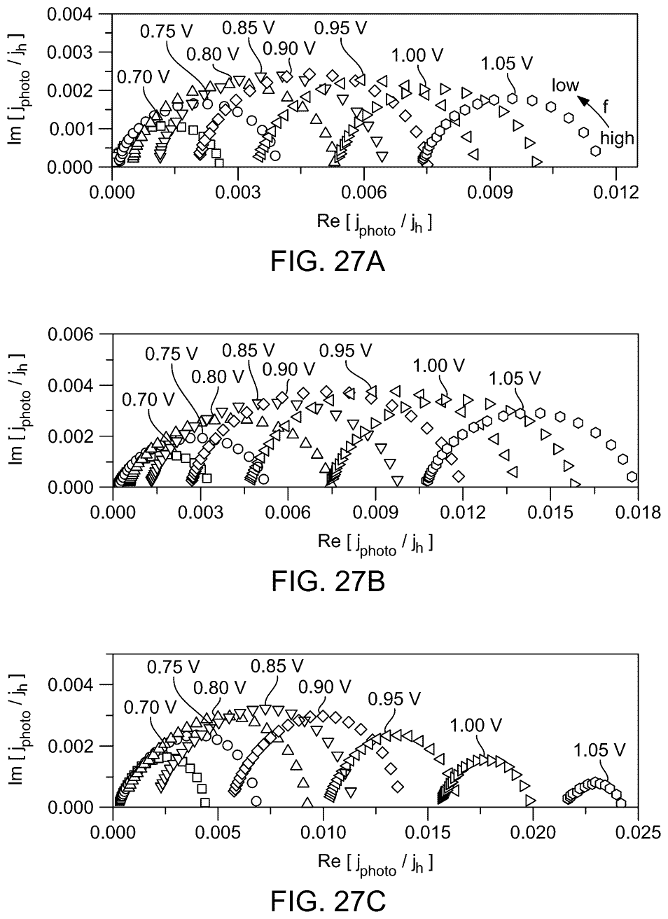

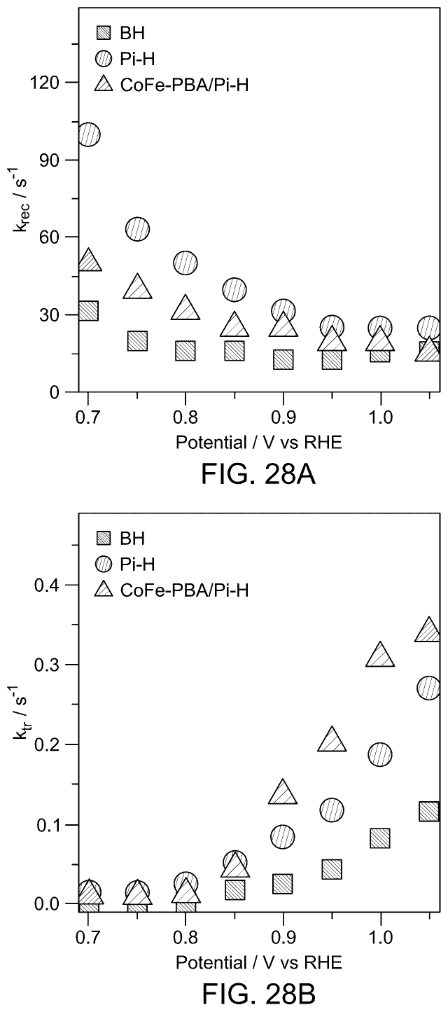

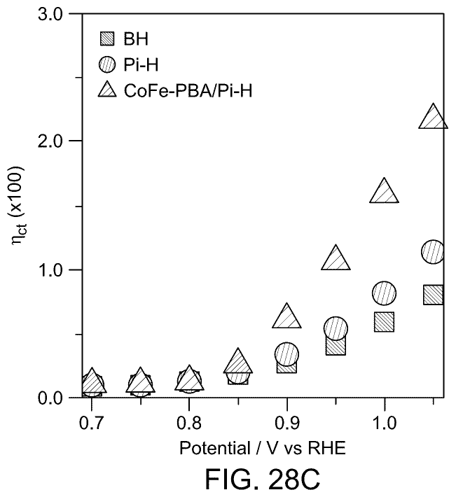

Phenomenological rate constants of charge transfer (kₜᵣ) and charge recombination (k_{rec}) at various bias potentials can be obtained by analyzing the positive/positive part of the IMPS spectra as shown in FIGS. 27A-27C. The LF intercept is related to the surface charge transfer efficiency (η_{ct}) and equal to kₜᵣ/(kₜᵣ+k_{rec}), whereas ωₘₐₓ=2πfₘₐₓ=kₜᵣ+k_{rec}. Then, kₜᵣ and k_{rec} can be calculated at various potentials from the low-frequency intercept and ωₘₐₓ for the BH, Pi-H, and CoFe-PBA/Pi-H photoanodes. FIGS. 28A-28C show calculated k_{rec} and kₜᵣ of the BH, Pi-H, and CoFe-PBA/Pi-H photoanodes at various potentials. FIGS. 28A-28C show that across the entire potential window the kₜᵣ increases in the following order: kₜᵣ (CoFe-PBA/Pi-H)>kₜᵣ (Pi-H)>kₜᵣ (BH) which is consistent with the LSV and EIS results.

The k_{rec} of Pi-H is higher than that of BH photoanode despite the latter exhibits lower PEC activity. Such behavior can be understood by considering that the accumulation of holes in the Pi layer facilitates, to a certain extent, the charge transfer kinetics at the SEI, but also increases the rate of recombination being consistent with TPC results (FIG. 19B). The reduced k_{rec} of the Pi-H photoanode after modification with the CoFe-PBA confirms that the CoFe-PBA OEC suppresses the surface recombination, more probably by passivating the defect sites, and enhances the charge transfer kinetics and ultimately the PEC water oxidation activity. Charge-transfer efficiencies (η_{ct}) of the BH, Pi-H, and CoFe-PBA/Pi-H have been calculated according to equation (10) and presented in FIG. 28C. Trends of η_{ct} are consistent with I-V curves presented in FIG. 17A.

$${η}_{ct} \% = {k}_{tr} x \frac{100}{{k}_{tr} + {k}_{rec}} \qquad ( 10 )$$

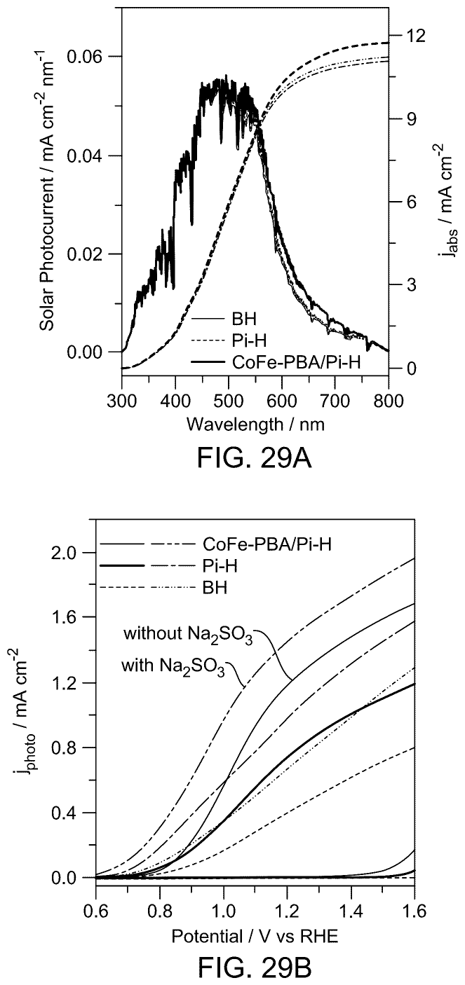

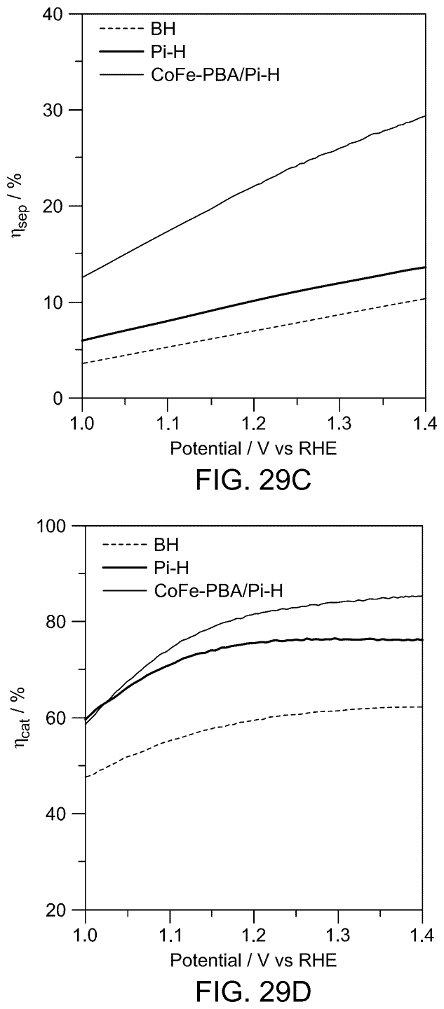

Efficiencies of charge separation (ηₛₑₚ) and charge transfer (η_{cat}) which represent the complete utilization of the surface holes by Na₂SO₃ electron donors and the surface hole injections, respectively. FIG. 29A shows solar photocurrent calculated by considering the fractions of light absorbed at various wavelengths under AM 1.5 G illumination. Integrated values of solar photocurrent (Jabs) are also presented in FIG. 29A. FIG. 29B shows density-voltage (J-V) curves of the BH, Pi-H, and CoFe-PBA/Pi-H photoanodes measured in an aqueous solution of NaOH with and without Na₂SO₃. The ηₛₑₚ and η_{cat} are defined as the ratios of Jₚₕₒₜₒ/J_{abs} and Jₚₕₒₜₒ/Jₚₕₒₜₒ(Na₂SO₃), respectively, and presented in FIG. 29C and FIG. 29D, respectively. Low ηₛₑₚ values were observed for the BH through the entire potential window due to the high rate of bulk and surface recombination. The modification of the BH with Pi layer has a little impact on the ηₛₑₚ indicating that the Pi alone is not adequate to suppress the recombination and improve the charge separation efficiency in agreement with the TPC and IMPS results.

On, modification with the CoFe-PBA, a significant improvement has been observed evincing that CoFe-PBA is important to suppress the surface recombination, passivate the surface defects, and accelerate the hole injection. The ηₛₑₚ of CoFe-PBA/Pi-H at 1.23 V_{RHE} (i.e. 23.4%) is improved by a factor of 3.1 and 2.2-fold relative to the BH (7.5%) and the Pi-H (10.7%), respectively. The analysis of the η_{cat} indicated the efficiency of hole injection is enhanced by 36 and 8.5% relative to those of BH and Pi-H at 1.23 V_{RHE}. The η_{cat} of the Pi-H is enhanced by 12.6% relative to that of the BH at 1.23 V_{RHE}, which indicates that surface defects (oxygen vacancies) created by the Pi layer on the surface of hematite have a positive impact on water oxidation, but the surface defects still cannot efficiently suppress the surface recombination. In general, the ηₛₑₚ and η_{cat} results indicated that the CoFe-PBA has a dual function. The CoFe-PBA passivates the surface states and enhances the separation efficiency and at the same time improves the hole injection and accelerates the water oxidation kinetics.

### Example 10: DFT Simulation

The DFT simulations have been conducted to further explore the effect of the phosphate ion (Pi) layer on the electrostatic potential of the hematite surface. The change of the surface electrostatic potential could influence the diffusion of the photogenerated holes toward the surface and thus affects the PEC catalytic activity as observed in the present study and supported by the TPC and IMPS results.

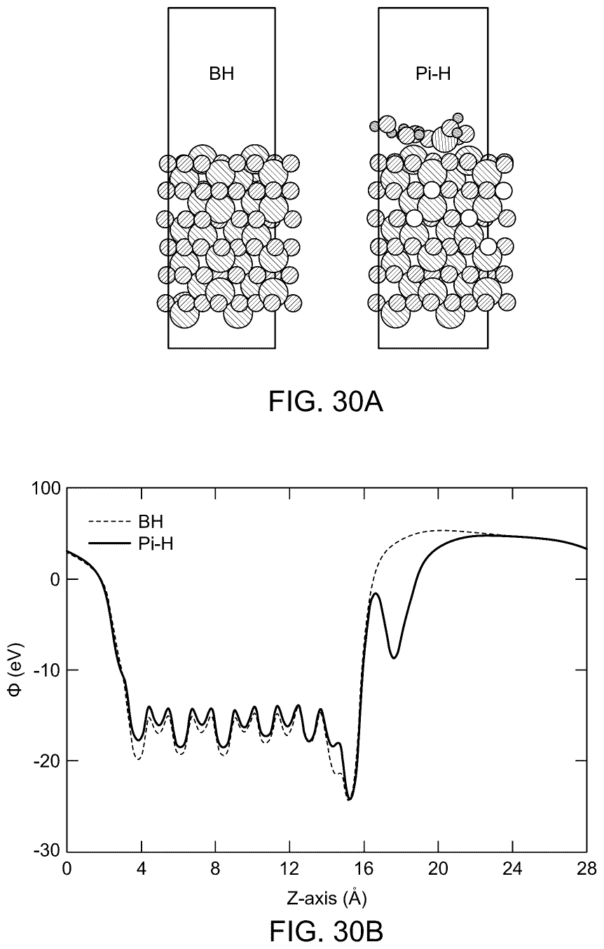

Several observations were observed from the published art such as the (001) surface is more stable than (110); therefore, only the (001) facet was focused. Based on the ATR-FTIR spectroscopy study of the adsorption of phosphate ions on hematite's surface, the mono-protonated mononuclear form is the dominant species. Therefore, the mono-protonated mononuclear form was modified as initial geometry for the adsorbed phosphate/hematite complex and was posed on an oxygen vacancy site. Results in FIGS. 30A-30B showed that the deposition of the Pi layer on the BH surface induced a drift on the BH's surface electrostatic potential toward more negative potential in agreement with the published art. Such a drift in the electrostatic potential is beneficial for the water oxidation reactions as the present drift makes the diffusion of the photogenerated holes toward the surface easier than in the BH. The present drift may also favor the formations of more oxygen-deficient vacancies (i.e., +1, +2 states). The defect stabilization comes from the strong electrostatic attraction between positively charged states and the Pi surface layer.

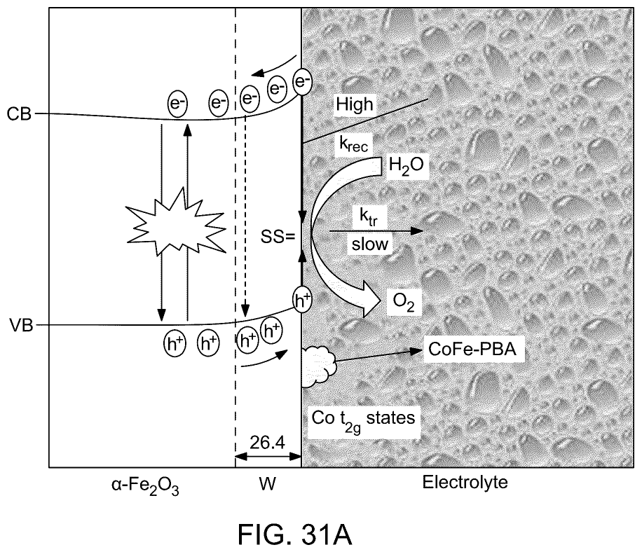

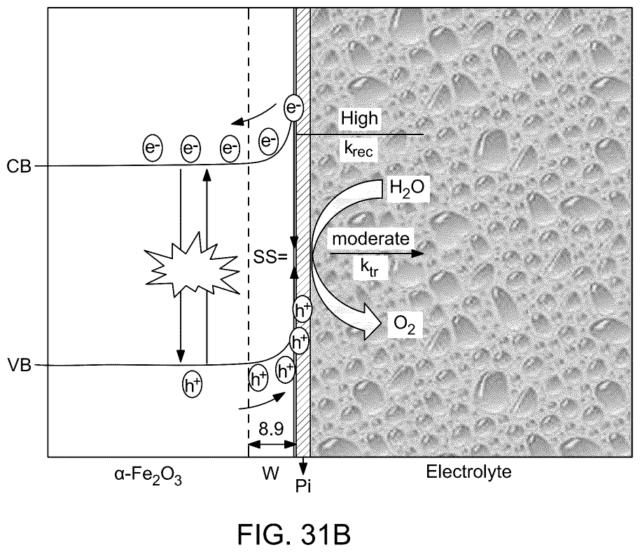

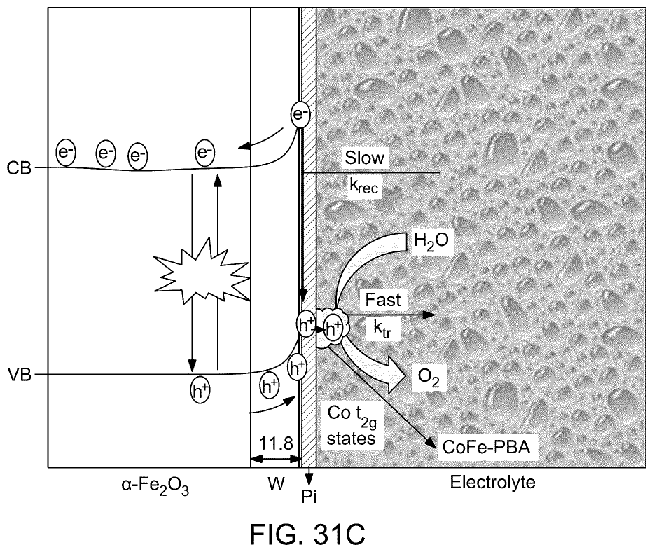

Based on the photoelectrochemical and the DFT calculation results, the roles of the Pi interfacial layer and CoFe-PBA OEC are schematically illustrated in FIG. 31A-31C. In the case of the BH photoanode (FIG. 31A), most of the photogenerated holes recombine within the bulk and few of the photogenerated holes can be separated by the electrical field within the space charge layer. Since the Lₚ of hematite is too short (2-3 nm), serious recombination takes place even in the space charge layer. In addition, since the energy level of the Co t_{2g} hole-acceptor states in CoFe-PBA are below the VB edge of hematite, there is no driving force for the hole transfer from the VB edge of hematite to the CoFe-PBA. Thus, the modification of hematite with CoFe-PBA only will not significantly improve its PEC activity as observed in the present study.

The modification of the hematite with the Pi layer facilitates the drift of photogenerated holes toward the surface, reduces the width of the depletion layer and shortens the charge collection distance, thus increasing the concentration of the holes at the surface. The modification of the hematite with the Pi layer also shifts the entire band structure anodically, and thus better energy band alignment is achieved between the energy level of Co t₂g hole-acceptor states in the CoFe-PBA and the VB edge of the hematite. In the absence of OEC (FIG. 31B), the holes are accumulated in the Pi layer at the defect sites which can catalyze the water oxidation but, at the same time, induce severe interfacial recombination at the semiconductor/electrolyte (S-E) interface. Thus, only a small fraction of the holes can transfer to the electrolyte and oxidize water and the rest recombine with the conduction band's electrons via surface states. The addition of the CoFe-PBA OEC to the Pi-H surface will passivate the surface defects and reduce the surface recombination. Moreover, the better match between the energy level of Co t_{2g} hole-acceptor states in the CoFe-PBA and the VB edge of the hematite modified with the Pi layer may facilitate the hole transfer from the VB of hematite to the CoFe-PBA. The synergy between the Pi layer and CoFe-PBA on the hematite is thus crucial to suppress the recombination of the surface accumulated holes with the conduction band electrons and to accelerate the water oxidation kinetics (FIG. 31C).

### Example 11: Equipment and Methods

Field emission scanning electron microscope (FESEM, TESCAN) operated at 20 kV acceleration voltage was used to characterize the morphology of the bare and modified hematite photoanodes. The XRD measurements were carried out in the range of 20 equal to 20°-70° using Rigaku X-ray diffractometer with Cu Kα (λ=0.15406 nm) as an X-ray radiation source. ESCALAB™ Xi⁺ X-ray photoelectron spectrometer (by Thermo Fisher Scientific, 168 Third Avenue, Waltham, MA USA 02451), equipped with a monochromatic micro-focused Al Kα X-ray source, was used for the X-ray photoelectron spectroscopy (XPS) analysis. The XPS spectra were calibrated by taking the C is peak at 284.8 eV as a reference. The Raman measurements were carried out by using the Scientific LabRAM HR Evolution Raman spectrometer (by HORIBA Instruments Incorporated, 5900 Hines Drive, Ann Arbor, Michigan, 48108). A He-Ne laser source working at 17 mW and 532 nm excitation wavelength with 100% laser power was used for the measurements. A 10× objective lens was used to focus the laser on hematite films, while the microscope was coupled with a 600.0 mm focal length spectrograph equipped with two switchable gratings. An acquisition time of 25 s with 2 accumulations was set for the Raman spectra collection for bare and modified hematite films. Diffuse reflectance spectra were recorded using Agilent Cary 5000 UV-Vis-NIR spectrophotometer equipped with integrating sphere accessories.

The present disclosure provides a cost-effective method of making the photoelectrode that increases the PEC water splitting efficiency. The PEC results revealed that the Pi interfacial layer increased the PEC activity of the CoFe-PBA/hematite photoanode. The Pi interfacial layer improves the PEC activity by 2.9-fold at 1.23 V_{RHE}. The Mott-Schottky plots analysis revealed that the Pi layer induces the formation of oxygen vacancies (i.e., in agreement with the XPS results) and reduces the space charge layer width. The Mott-Schottky analysis together with the bandgap calculation indicated that the entire band structure of hematite is anodically shifted upon modification with the Pi layer. The analysis of time and frequency-resolved results revealed that the synergy between the Pi layer and CoFe-PBA catalyst prolongs the photogenerated holes lifetime, reduces corresponding charge transfer resistance, and suppresses the surface recombination.

The DFT simulations revealed that the Pi interfacial layer drifts the electrostatic potential of the hematite's surface toward more negative potential and thus facilities the diffusion of the positively charged holes toward the hematite/CoFe-PBA/electrolyte interfaces making the positively charged holes dynamically available to oxidize water on CoFe-PBA catalyst, which energetically promote the transfer of the photogenerated holes from the valance band of hematite to the Co t₂g hole-acceptor states in the CoFe-PBA, where the photogenerated holes can be efficiently involved in water oxidation process. The IMPS results confirmed that via the interfacial layer approach, the rate constant of surface recombination could be greatly suppressed, whereas the efficiency of charge transfer could be greatly enhanced. The charge separation and charge transfer tests performed in the presence of electron donors (Na₂SO₃) indicated that the CoFe-PBA OEC has a dual-function (i.e., passivation and catalysis).

Numerous modifications and variations of the present disclosure are possible in light of the above teachings. It is therefore to be understood that within the scope of the appended claims, the invention may be practiced otherwise than as specifically described herein.

1: A photoelectrode, comprising:
a transparent substrate;
a layer of crystalline hematite nanoparticles at least partially covering a surface of the transparent substrate;
a phosphate ions (Pi) interfacial layer coated on a surface of the layer of crystalline hematite nanoparticles; and
a plurality of CoFe-Prussian blue analogues (CoFe-PBA) particles uniformly disposed on a surface of the phosphate (Pi) interfacial layer.

2: The photoelectrode of claim 1, wherein the transparent substrate comprises a glass substrate, and wherein the glass substrate is at least one selected from the group consisting of a fluorine doped tin oxide (FTO) coated glass substrate, a tin doped indium oxide (ITO) coated glass substrate, an aluminum doped zinc oxide (AZO) coated glass substrate, a niobium doped titanium dioxide (NTO) coated glass substrate, an indium doped cadmium oxide (ICO) coated glass substrate, an indium doped zinc oxide (IZO) coated glass substrate, a fluorine doped zinc oxide (FZO) coated glass substrate, a gallium doped zinc oxide (GZO) coated glass substrate, an antimony doped tin oxide (ATO) coated glass substrate, a phosphorus doped tin oxide (PTO) coated glass substrate, a zinc antimonate coated glass substrate, a zinc oxide coated glass substrate, a ruthenium oxide coated glass substrate, a rhenium oxide coated glass substrate, a silver oxide coated glass substrate, and a nickel oxide coated glass substrate.

3: The photoelectrode of claim 1, wherein the transparent substrate is an FTO coated glass substrate.

4: The photoelectrode of claim 1, wherein the layer of crystalline hematite nanoparticles has an average thickness of 100 to 1000 nanometers (nm).

5: The photoelectrode of claim 1, wherein the crystalline hematite nanoparticles are in the form of nanorods having an average diameter of 50 to 150 nm, and an average length of 100 to 800 nm.

6: The photoelectrode of claim 1, wherein the crystalline hematite nanoparticles are in the form of nanorods having an average diameter of 80 to 120 nm, and an average length of 350 to 550 nm.

7: The photoelectrode of claim 1, wherein the Pi interfacial layer has an average thickness of 1 to 20 nm.

8: The photoelectrode of claim 1, wherein the Pi interfacial layer has an average thickness of 5 to 10 nm.

9: The photoelectrode of claim 1, wherein the Pi interfacial layer comprises phosphate ions selected from the group consisting of HPO₄⁻², H₂PO₄⁻², PO₄⁻³, H₃PO₃, HPO₃⁻², H₂PO₃⁻², and PO₃⁻³.

10: The photoelectrode of claim 1, wherein the particles of CoFe-Prussian blue analogues (CoFe-PBA) are in the form of nanocubes having an average edge length of 5 to 20 nm.

11: The photoelectrode of claim 1, having a photocurrent density of 1 to 2 milliampere per square centimeter (mA/cm²) at a potential of 1.23 V_{RHE}; and
an incident photon-to-current conversion efficiency (IPCE) up to 40% at 430 nm wavelength.

12: The photoelectrode of claim 1, having a photocurrent density at 1.23 V_{RHE} that is at least 1-fold greater compared to a second photoanode without the CoFe-PBA particles disposed Pi interfacial layer, when incorporated into a photoelectrochemical cell for electrolysis of water into oxygen.

13: The photoelectrode of claim 12, wherein the photocurrent density is increased by 0.4 to 1 mA/cm² at 1.23 V_{RHE}.

14: A method of making the photoelectrode of claim 1, comprising;
immersing the transparent substrate in a first solution comprising FeCl₃ and heating to form a β-FeOOH film on a surface of the transparent substrate;
wherein the transparent substrate is an FTO coated glass substrate;
heating and calcining the β-FeOOH film at a temperature of at least 800 degrees Celsius (° C.) to form a crystalline hematite film;
immersing the crystalline hematite film in a second solution comprising phosphate ions (Pi) to form a crude Pi modified hematite film;
removing the transparent substrate having the crude Pi modified hematite film from the second solution and heating the transparent substrate having the crude Pi modified hematite film at a temperature of at least 300° C. to form a Pi modified hematite film; and
sequentially dipping and drying the Pi modified hematite film in a third solution comprising a ferricyanide salt and a fourth solution comprising a cobalt salt to form a CoFe/Pi modified hematite film on the surface of the transparent substrate.

15: The method of claim 14, wherein the phosphate ions are selected from the group consisting of HPO₄⁻², H₂PO₄⁻², PO₄⁻³, H₃PO₃, HPO₃⁻², H₂PO₃⁻², and PO₃⁻³.

16: The method of claim 14, wherein the phosphate ions are present in the second solution at a concentration of 0.1 to 1 molar (M), and the second solution has a pH value in a range of 4 to 8.

17: The method of claim 14, wherein the ferricyanide salt comprises ferricyanide and positively charged counter ions, and wherein the positively charged counter ions are selected from the group consisting of alkaline earth metal ions, alkali metal ions, quaternary ammonium ions having a formula of NR4⁺, with R being the same or various alkyl or aryl groups.

18: The method of claim 14, wherein the cobalt salt comprises cobalt sulfate, cobalt acetate, cobalt citrate, cobalt iodide, cobalt chloride, cobalt perchlorate, cobalt nitrate, cobalt phosphate, cobalt triflate, cobalt bis(trifluoromethanesulfonyl)imide, cobalt tetrafluoroborate, cobalt bromide, and/or a hydrate thereof.

19: The method of claim 14, wherein the heating the crude Pi modified hematite film after being removed from the second solution is carried out for at least 30 minutes at a temperature of at least 300° C.

20: A method of photoelectrochemical (PEC) water splitting, comprising;
irradiating a photochemical cell comprising the photoelectrode of claim 1 and water with sunlight to form hydrogen and oxygen.
